(19) United States
(12) Patent Application Publication
(10) Pub. No.: US 2018/0079989 A1
(43) Pub. Date: Mar. 22, 2018

(54) NANOSHEET COMPOSITIONS AND THEIR USE IN LUBRICANTS AND POLISHING SLURRIES

(71) Applicants: Hong LIANG, College Station, TX (US); Huaping XIAO, College Station, TX (US); Xingliang HE, College Station, TX (US); Chung-jwa KIM, College Station, TX (US); Yunyun CHEN, College Station, TX (US); The Texas A&M University System, College Station, TX (US)

(72) Inventors: Hong Liang, College Station, TX (US); Huaping Xiao, College Station, TX (US); Xingliang He, College Station, TX (US); Chung-jwa Kim, College Station, TX (US); Yunyun Chen, College Station, TX (US)

(73) Assignee: The Texas A&M University System, College Station, TX (US)

(21) Appl. No.: 15/190,935

(22) PCT Filed: Dec. 23, 2014
(86) PCT No.: PCT/US2014/072212

§ 371 Date: Jun. 23, 2016

Related U.S. Application Data
(60) Provisional application No. 61/920,391, filed on Dec. 23, 2013.

(51) Int. Cl. C10M 169/02; C09G 1/02; C10M 113/08; C10M 113/16; C10M 101/00; C10M 171/06

(52) U.S. Cl. CPC C10M 169/02; C09G 1/02; C10M 113/08; C10M 113/16; C10M 101/00; C10M 171/06; C10N 2250/10; C10M 2201/0853; C10M 2203/003; C10N 2220/082; C10N 2230/06; C10N 2250/12; C10M 2201/0626

(57) ABSTRACT

Lubrication and friction reduction improves fuel efficiency and reduces energy consumption. Effective and controllable material removal results in superior surface finishing and planarization. Nanosheets are developed with specific functionalization that can be used to reduce friction and wear, improve the fluidic property, and rheological performance

The nanosheets can be from the graphite family, transition metal dichalcogenides, transition metal trichalcogenides, semiconducting chalcogenides, metal oxides, layered hydroxides, clays, ternary transition metal carbides and nitrides, and zirconium phosphates and phosphonates, and their corresponding dopants.

Tribological, rheological, and polishing applications include lubricants, viscosity modification, and chemical-mechanical planarization. The nanosheets are useful in improving efficiency and lifetime of machinery, saving energy for mechanical operations, and optimizing manufacturing processes in surface engineering.

### RELATED APPLICATIONS

This application claims priority to U.S. Provisional Patent Application 61/920,391 filed on Dec. 23, 2013 which is specifically incorporated by reference in its entirety herein.

### FIELD

The disclosure relates generally to nanostructures. The disclosure relates specifically use of nanostructures in lubrication and slurries for chemical mechanical planarization.

### BACKGROUND

Additives can be added to lubricants to decrease friction and wear, improve efficiency, reduce heat generation, and increase energy savings.

The decreasing size of integrated circuits requires a high degree of flatness after polishing by chemical-mechanical planarization. Standard industrial slurries can result in high within-wafer-nonuniformity (WIWNU), surface roughness, and dishing (the difference between the low point and high point of the wafer).

It would therefore be advantageous to have a nanostructure additive that provides improved lubrication through friction reduction and viscosity modification. It would also be advantageous to have a nanostructure-containing slurry with improved slurry transport and contact between the polishing pad and the wafer surface to increase the manufacturing yield of integrated circuits.

### SUMMARY

An embodiment of the disclosure is a suspension, comprising: a plurality of nanosheets (NS), wherein a nanosheet has a length ranging from about 10 nm to about 10 μm; wherein the nanosheet has a thickness of less than 90 nm; and a substance capable of suspending the plurality of nanosheets. In an embodiment, the thickness is less than 50 nm. In a further embodiment the nanosheets have an aspect ratio of at least 10. In yet another embodiment, the nanosheets are comprised of one of the group consisting of: graphene, fluoro-graphene, graphene oxide, BCN, h-BN (white graphene), MoS₂, WS₂, MoSe₂, WSe₂, TiTe₃, MnPS₃, MoTe₂, WTe₂, ZrS₂, ZrSe₂, TiS₂, VSe₂, GaSe, GaTe, InSe, Bi₂Se₃, Bi₂Te₃, Bi₂MnTe₄, NbSe₂, NbS₂, LaSe, TaS₂, NiSe₂, semiconducting chalcogenides, metallic dichalcogenide, micas, BSCCO, MoO₃, WO₃, TiO₂, MnO₂, V₂O₅, TaO₃, RuO₂, Y₂O₃, TiNbO₅, K_{0.8}H_{3.2}Nb₆O₁₇, LaNb₂O₇, La_{0.90}Eu_{0.05}Nb₂O₇, (Ca,Sr)₂Nb₃O₁₀, Ca₂Ta₂TiO₁₀, Bi₄Ti₃O₁₂, Bi₂SrTa₂O₉, Bi_{3.25}La_{0.75}Ti₃O₁₂, K₂NbO₃F, Ni(OH)₂, Mg(OH)₂, Sm(OH)₃, Er(OH)₃, Eu(OH)₃, Y(OH)₃, Co—Al(OH)ₓ, Mg—Al(OH)ₓ, perovskite-type oxides, hydroxides, Ti₃AlC₂, Ti₂AlC, Ta₄AlC₃, (Ti_{0.5},Nb_{0.5})₃AlC, (V_{0.5}Cr_{0.5})₃AlC₂, Ti₃AlCN, zirconium phosphates, abrasives, Al₂O₃, SiO₂, CeO₂, and diamond particles and their corresponding dopants. In yet another embodiment, the nanosheets are comprised of Y₂O₃. In another embodiment, the nanosheets are comprised of zirconium phosphate. In an embodiment, the concentration of the nanosheets in the substance is between 0.0004 wt % and 1.0 wt %. In an embodiment, the concentration of the nanosheets in the substance is 0.5 wt %. In another embodiment the substance is selected from the group consisting of water, mineral oil, paraffinic oil, naphthenic oil, synthetic hydrocarbon fluids, ester oil, silicone oil, polyphenyl ethers (PPE), perfluoropolyether (PFPE), hydrogenated polyolefins, synthetic oil, vegetable oil, and animal fats. In another embodiment, the nanosheets have a major face that is substantially square, rectangular, circular, other polygon-shaped, or irregularly shaped. In yet another embodiment, the suspension is a lubricant. In an embodiment, the lubricant further comprises additives for deposit control, film-forming, anti-wear, corrosion inhibition, or sealing. In an embodiment, the lubricant is selected from the group consisting of solid and semi-solid. In another embodiment, the semi-solid lubricant is selected from the group consisting of grease, standard thread compounds, and petroleum jelly.

An embodiment of the disclosure is a method of lubricating a surface comprising applying the lubricant to a surface. In another embodiment, the substance is selected from the group consisting of a liquid, solid, and semi-solid. In yet another embodiment, the nanosheets have an aspect ratio of at least 10. In a further embodiment, the nanosheets are comprised of one of the group consisting of: graphene, fluoro-graphene, graphene oxide, BCN, h-BN (white graphene), MoS₂, WS₂, MoSe₂, WSe₂, TiTe₃, MnPS₃, MoTe₂, WTe₂, ZrS₂, ZrSe₂, TiS₂, VSe₂, GaSe, GaTe, InSe, Bi₂Se₃, Bi₂Te₃, Bi₂MnTe₄, NbSe₂, NbS₂, LaSe, TaS₂, NiSe₂, semiconducting chalcogenides, metallic dichalcogenide, micas, BSCCO, MoO₃, WO₃, TiO₂, MnO₂, V₂O₅, TaO₃, RuO₂, Y₂O₃, TiNbO₅, K_{0.8}H_{3.2}Nb₆O₁₇, LaNb₂O₇, La_{0.90}Eu_{0.05}Nb₂O₇, (Ca,Sr)₂Nb₃O₁₀, Ca₂Ta₂TiO₁₀, Bi₄Ti₃O₁₂, Bi₂SrTa₂O₉, Bi_{3.25}La_{0.75}Ti₃O₁₂, K₂NbO₃F, Ni(OH)₂, Mg(OH)₂, Sm(OH)₃, Er(OH)₃, Eu(OH)₃, Y(OH)₃, Co—Al(OH)ₓ, Mg—Al(OH)ₓ, perovskite-type oxides, hydroxides, Ti₃AlC₂, Ti₂AlC, Ta₄AlC₃, (Ti_{0.5},Nb_{0.5})₃AlC, (V_{0.5}Cr_{0.5})₃AlC₂, Ti₃AlCN, zirconium phosphates, abrasives, Al₂O₃, SiO₂, CeO₂, and diamond particles. In an embodiment, the nanosheets are comprised of Y₂O₃. In another embodiment, the nanosheets are comprised of zirconium phosphate. In an embodiment, the concentration of the nanosheets in the substance is between 0.0004 wt % and 1.0 wt %. In a further embodiment, the concentration of the nanosheets in the substance is 0.5 wt %. In yet another embodiment, the substance is selected from the group consisting of water, mineral oil, paraffinic oil, naphthenic oil, synthetic hydrocarbon fluids, ester oil, silicone oil, polyphenyl ethers (PPE), perfluoropolyether (PFPE), hydrogenated polyolefins, synthetic oil, vegetable oil, and animal fats.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1A-1C are transmission electron microsopy (TEM) images of silica nanoparticles (NP) based slurry, boron NPs based slurry, and multiphase Y₂O₃ NS based slurry;

FIG. 2 depicts an atomic force microscopy (AFM) image of a Y₂O₃ NS showing its two-dimensional morphology;

FIG. 3 is a chart of WIWNU for commercial SiO₂ slurry vs. Y₂O₃ NS slurry before and after CMP;

FIG. 4 depicts the results of friction between the Cu film and the polishing pad in SiO₂ (top) and Y₂O₃ (bottom) slurries;

FIG. 5 depicts the results of rheological measurements;

FIG. 6 depicts schematic representations of abrasion modes using (FIG. 6A) the commercial SiO₂ slurry and (FIG. 6B) the Y₂O₃ NS slurry;

FIG. 7 depicts the Cu dishing in wafers that are polished using a commercial SiO₂ or Y₂O₃ NS slurry;

FIG. 8 depicts the AFM image of the multiphase Y₂O₃ NS;

FIG. 9 depicts a comparison of XRD patterns among the commercial multiphase Y₂O₃ powder (bottom pattern), the multiphase Y₂O₃ NS (middle pattern), and the single-phase cubic Y₂O₃—Cu NS (top pattern);

FIG. 10 depicts selected area electron diffraction (SAED) patterns of multiphase Y₂O₃ NS;

FIG. 11 depicts the TEM images of Y₂O₃ NS (FIG. 11A), Y₂O₃ NP (FIG. 11B), and Y₂O₃ nanowires (NW) (FIG. 11C);

FIG. 12 depicts comparison of friction coefficient between boundary lubrication and hydrodynamic lubrication using the mineral oil containing 0.1 wt % of Y₂O₃ NS additives.

FIG. 13 depicts Stribeck curves of mineral oil (top plot), and with addition of 1 wt % (second from top plot), 0.5 wt % (second from bottom plot) and 0.1 wt % (bottom plot) Y₂O₃ NS additives;

FIG. 14A depicts variation of viscosity with shear rate in mineral oil (top plot), and with addition of 0.5 wt % (middle plot) and 0.1 wt % (bottom plot) Y₂O₃ NS additives. FIG. 14B depicts reduction in viscosity of mineral oil (top plot) in the presence of Y₂O₃ NS with concentrations of 0.5 wt % (middle plot) and 0.1 wt % (bottom plot) under a constant shear rate (10000 s⁻¹);

FIG. 15A-FIG. 15B depict optical microscope images of the reference grease (left) and the grease with Y₂O₃ (right) at 1000× magnification;

FIG. 16A-FIG. 16B depict comparison of the coefficient of friction (CoF) from different concentrations;

FIG. 17 depicts the comparison of the CoF under different loads;

FIG. 18 depicts comparison of the CoF at different rotating speeds;

FIG. 19 depicts comparison of the CoF with increased temperature;

FIG. 20 depicts optical microscope images of the wear scar of the reference grease (FIG. 20A) and the grease with Y₂O₃ (FIG. 20B) at 200 times magnification;

FIG. 21 depicts optical microscopy images of wear track of the reference grease (FIG. 21A, 21B) and the grease with Y₂O₃ (FIG. 21C-21D) at 100 times (FIG. 21A, 21C) and 1000 times (FIG. 21B, 21D) magnification;

FIG. 22 depicts interferometer results on the grease without (FIG. 22A) and with Y₂O₃ (FIG. 22B);

FIG. 23 depicts comparison of wear rate;

FIG. 24 depicts illustration of the role of Y₂O₃ NSs between sliding surfaces;

FIG. 25 depicts a field emission scanning electron microscopy (FESEM) image of α-ZrP nanoplatelets;

FIG. 26 depicts XRD patterns of the α-ZrP nanoplatelets;

FIG. 27 depicts dry friction results with α-ZrP additives (top curve), graphite additives (bottom curve), and without any additives (middle curve);

FIG. 28A-FIG. 28B depict (FIG. 28A) Stribeck curves of mineral oil (top plot), and with addition of 0.5 wt % (middle plot) and 0.1 wt % (bottom plot) α-ZrP nanoplatelets additives. (FIG. 28B) Stribeck curves of DI water (top plot), and with addition of 0.002 wt % (middle plot) and 0.0004 wt % (bottom plot) α-ZrP nanoplatelets additives;

FIG. 29A-FIG. 29D depict variation of viscosity with shear rate in mineral oil (top plot), and with addition of 0.5 wt % (middle plot) and 0.1 wt % (bottom plot) α-ZrP nanoplatelets additives;

FIG. 30A-FIG. 30B depict (FIG. 30A) comparison of infrared spectra of α-ZrP nanoplatelets (top curve), mineral oil (bottom curve), and mineral oil containing 0.5 wt % α-ZrP nanoplatelets (middle curve). (FIG. 30B) Comparison of Raman spectra between α-ZrP nanoplatelets (top curve) and mineral oil containing 0.5 wt % α-ZrP nanoplatelets (bottom curve);

FIG. 31A-FIG. 31G depict powder X-ray diffraction (XRD) patterns (FIG. 31A), SEM (FIG. 31B, FIG. 31C, FIG. 31D) and TEM (FIG. 31E, FIG. 31F, FIG. 31G) images of α-ZrP with and without intercalation;

FIG. 32 depicts an idealized representation of amine intercalation process;

FIG. 33 depicts TGA of butylamine intercalated ZrP (●curve), propylamine intercalated ZrP (▴curve) and ethylenediamine intercalated ZrP (▾curve);

FIG. 34A-FIG. 34C depict friction coefficient as a function of rpm/N obtained in a heavy mineral oil with intercalated α-ZrP additives. (FIG. 34A). Ethylenediamine intercalated. (FIG. 34B) Propylamine intercalated. (FIG. 34C). Butylamine intercalated. Symbols present obtained measurements and solid lines are smoothed results;

FIG. 35A-FIG. 35C depict (FIG. 35A) schematic of contact area with α-ZrP additives at low speed/load region; (FIG. 35B) contact area at high speed/load region with laminar flow; and (FIG. 35C) relationship between drag coefficient and interlayer space.

FIG. 36A-FIG. 36B depict determination of the CoF at varying concentrations of α-ZrP;

FIG. 37 depicts determination of the CoF at varying loads (between 3-9N) and varying speed (50-150 RPM) for 2 minutes;

FIG. 38 depicts a graph of temperature vs. CoF for 0.5 wt % α-ZrP and reference grease;

FIG. 39 depicts determination of the friction factor between the reference grease and 0.5 wt % α-ZrP;

FIG. 40 depicts the wear rate, FIG. 40A, wear depth, FIG. 40B, wear width, FIG. 40C, and the friction response, FIG. 40D, with the reference grease and 0.5 wt % ZrP; and

FIG. 41A-FIG. 41F depict a comparison of the morphology of the wear track with the reference grease and with the addition of α-ZrP

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “suspension” means and refers to the state of a substance when its particles are mixed with but undissolved in a fluid or solid.

Nanomaterials can be synthesized in varying shapes. Nanomaterials can form including, but not limited to, nanosheets, nanoparticles, nanowires, and nanoplatelets.

One application for nanomaterials is as a polishing slurry (e.g., chemical mechanical planarization (CMP)). Another application is as a lubricant, including both liquid and solid lubricants.

Improved materials are provided having a two-dimensional (2D) sheet-like form. These nanosheets can be formed from inorganic or organic materials and find use in a variety of applications.

In an embodiment, the nanosheets can be from the graphite family (e.g. graphene, h-BN), transition metal dichalcogenides (e.g. MoS₂, WS₂), transition metal trichalcogenides (e.g. TiTe₃, MnPS₃), semiconducting chalcogenides (e.g. MoTe₂, GaSe), metal oxides (Y₂O₃, MoO₃), layered hydroxides (e.g. Ni(OH)₂, Mg(OH)₂), clays (e.g. layered silicates), ternary transition metal carbides and nitrides (e.g. Ti₃AlC₂, Ti₃AlCN), and zirconium phosphates and phosphonates (e.g. α-Zr(HPO₄)₂.H₂O, γ-Zr(PO₄)(H₂PO₄).2H₂O) and their corresponding dopants.

In an embodiment, the nanosheets are selected from the group consisting of: graphene, fluoro-graphene, graphene oxide, BCN, h-BN (white graphene), MoS₂, WS₂, MoSe₂, WSe₂, TiTe₃, MnPS₃, MoTe₂, WTe₂, ZrS₂, ZrSe₂, TiS₂, VSe₂, GaSe, GaTe, InSe, Bi₂Se₃, Bi₂Te₃, Bi₂MnTe₄, NbSe₂, NbS₂, LaSe, TaS₂, NiSe₂, semiconducting chalcogenides, metallic dichalcogenide, micas, BSCCO, MoO₃, WO₃, TiO₂, MnO₂, V₂O₅, TaO₃, RuO₂, Y₂O₃, TiNbO₅, K_{0.8}H_{3.2}Nb₆O₁₇, LaNb₂O₇, La_{0.90}Eu_{0.05}Nb₂O₇, (Ca,Sr)₂Nb₃O₁₀, Ca₂Ta₂TiO₁₀, Bi₄Ti₃O₁₂, Bi₂SrTa₂O₉, Bi_{3.25}La_{0.75}Ti₃O₁₂, K₂NbO₃F, Ni(OH)₂, Mg(OH)₂, Sm(OH)₃, Er(OH)₃, Eu(OH)₃, Y(OH)₃, Co—Al(OH)ₓ, Mg—Al(OH)ₓ, perovskite-type oxides, hydroxides, Ti₃AlC₂, Ti₂AlC Ta₄AlC₃ (Ti_{0.5} Nb_{0.5})₃AlC, (V_{0.5}Cr_{0.5})₃AlC₂, Ti₃AlCN, zirconium phosphates, abrasives, Al₂O₃, SiO₂, CeO₂, and diamond particles, among others. Nanosheets can be comprised of any 2D NP capable of acting as a lubricant or CMP slurry.

Synthesis of representative nanosheets of Y₂O₃ is described herein. While Y₂O₃ nanosheets are disclosed as a representative embodiment, it will be appreciated that other nanosheet materials are also encompassed by the disclosure.

Generally, the nanosheets have a longest dimension (e.g., diameter or edge length) from about 10 nm to about 10 μm, and a thickness of less than 90 nm.

In one embodiment, the nanosheets have an aspect ratio of at least 10. The aspect ratio is the ratio of the longest:shortest dimension. In one embodiment the nanosheets have an aspect ratio of from 10 to 1000.

In one embodiment, the nanosheets have a major face that is substantially square, rectangular, circular, other polygon-shaped, or irregularly shaped.

### Nanosheet Suspensions

In an embodiment, the nanosheets are in a suspension. The nanosheet suspension comprises a plurality of nanosheets, wherein the nanosheets have a longest dimension (e.g., diameter or edge length) from about 10 nm to about 10 μm, and a thickness of less than 90 nm; and a liquid capable of suspending the plurality of nanosheets. In an embodiment, the thickness is less than 50 nm.

Nanosheets of the disclosed dimensions are integrated into a liquid in order to form a suspension. As will be discussed below, the suspensions can be polishing slurries, lubricants, or provide other functions known to those of skill in the art.

### Nanosheet Slurry

In one embodiment, the suspension is a polishing slurry. The polishing slurry can be used for abrading a surface. The provided slurries can be used in any application for abrading a surface.

In one embodiment, the liquid is selected from the group consisting of water, mineral oil, paraffinic oil, naphthenic oil, synthetic hydrocarbon fluids, ester oil, silicone oil, polyphenyl ethers (PPE), perfluoropolyether (PFPE), vegetable oils, and animal fats.

The nanosheet slurries can contain additional additives. For example, typical slurries contain one or more of: water, a suspension, a corrosion inhibitor, a pH justifier, abrasives, an oxidizer, complex agents, friction modifier.

### CMP Slurry

In one embodiment, the suspension is a CMP slurry. CMP slurries are highly specialized slurries with ability to remove material during microelectronic processing in a particular manner (e.g., global planarization). By incorporating the nanosheets into a CMP slurry, improved planarization is provided.

In one embodiment, the liquid is water. In one embodiment, the slurry further comprises a complexing agent selected from the group consisting of citric acid, ammonia, amino acids, other organic acids, 3,4-dihydroxybenzoic acid, oxalic acid, and phthalate compounds. In one embodiment, the pH is from 3 to 10.

In one embodiment, the slurry further comprises an oxidizer selected from the group consisting of hydrogen peroxide, nitric acid, ferric nitrate, potassium permanganate, dichromates, ammonium persulfate, and iodate.

In one embodiment, the slurry further comprises a corrosion inhibitor selected from the group consisting of benzotriazole, 2-mercaptobenzoxale (MBO), benzimidazole, 5-aminotetrazole monohydrate (ATA), 5-phenyl-1H-tetrazole (PTA), and 1-phenyl-1H-tetrazole-5-thiol (PTT).

In one embodiment, the slurry further comprises a surfactant selected from the group consisting of ammonium lauryl sulfate, sodium dodecyl sulfate, sodium myreth sulfate, Sodium dodecylbenzenesulfonate, perfluorooctanesulfonate, perfluorobutanesulfonate, perfluorooctanoic acid, cetyl trimethylammonium bromide, benzethonium chloride, benzalkonium chloride, and cocamidopropyl betaine.

Nanosheet materials for CMP slurries are particularly suited for CMP applications. In one embodiment, the nanosheets comprise a material selected from the group consisting of: graphene oxide, BCN, h-BN; metallic dichalcogenides: MoS₂, WS₂, MoSe₂, WSe₂, ZrS₂, ZrSe₂, TiTe₃, MnPS₃; oxides: MoO₃, WO₃, TiO₂, MnO₂, V2O₅, Y₂O₃, etc.; hydroxides: Ni(OH)₂, Mg(OH)₂, Sm(OH)₃, Er(OH)₃, Eu(OH)₃, Y(OH)₃, etc.; and zirconium phosphates, among others. Nanosheets can be comprised of any 2D NP capable of acting as a lubricant or CMP slurry.

### CMP Method

The nanosheet slurries can be integrated into any known CMP method. Therefore, in another aspect a method of chemical mechanical planarization is provided.

In one embodiment, the method comprises: providing a CMP slurry in contact between a surface to be polished and a polishing pad; and rotating at least one of the polishing pad and the surface to be polished while applying pressure there between. In one embodiment, the polishing pad is selected from the group consisting of poly urethane based (e.g., POLITEX), fiber glass, polymer composite, polyetherene, polyurethane, polyurea, polyester, polyacrylate, and polyvinyl chloride. In one embodiment, the pressure applied is from 0.1 to 5 psi. In one embodiment, the rotation speed relates to the pad and is from 5 to 200 rpm. In one embodiment, the rotation speed relates to the wafer and is from 5 to 200 rpm. In one embodiment, the surface comprises a material with features to be polished selected from the group consisting of Cu, Ta, W, Al, SiO₂, and low K materials. In one embodiment, the method further comprises removing the CMP slurry (which is more efficient than with non-nanosheet slurries).

### Liquid Lubricants

In one embodiment, the suspension is a lubricant. The nanosheet suspension can also be formulated as a lubricant instead of a polishing slurry.

In one embodiment, the liquid is selected from the group of water and an oil selected from the group consisting of mineral oil, paraffinic oil, naphthenic oil, synthetic hydrocarbon fluids, ester oil, silicone oil, polyphenyl ethers (PPE), perfluoropolyether (PFPE), vegetable oils, and animal fats.

In one embodiment, the lubricant further comprises additives for deposit control, film-forming, anti-wear, corrosion inhibition, or sealing.

### Lubricant Method

In another aspect, a method of lubricating a surface is provided. In one embodiment, the method comprises applying a lubricant as disclosed herein to the surface.

### Solid and Semi-Solid Lubricants

In another aspect, a solid or semi-solid lubricant (grease) is provided. In one embodiment, the solid or semi-solid lubricant comprises a plurality of nanosheets, wherein the nanosheets have a longest dimension (e.g., diameter or edge length) from about 10 nm to about 10 μm, and a thickness of less than 90 nm. In an embodiment, the thickness is less than 50 nm.

In an embodiment, the lubricant is a non-liquid lubricant. Accordingly, both solid and semi-solid lubricants are contemplated. As used herein, semi-solid lubricants are substances such as grease, standard thread compounds, petroleum jelly (e.g., Vaseline). With particular regard to greases formed using the nanosheets, the greases can be used as seals and lubricants under high shear stress. In certain embodiments the greases can be used at elevated temperatures (e.g., 200° C.).

Representative nanosheet materials that can be incorporated into solid or semi-solid lubricants include: graphene, graphite powder (micro and nano) particles, h-BN (white graphene); MoS₂, WS₂, MoSe₂, WSe₂, GaSe, TiTe₃, MnPS₃; WO₃, MoO₃, Naₓ(Mn⁴⁺,Mn³⁺)₂O₄, Sr₂RuO₄, H₃BO₃; oxides: MoO₃, WO₃, TiO₂, MnO₂, V₂O₅, Y₂O₃, etc.; hydroxides: Ni(OH)₂, Mg(OH)₂, Sm(OH)₃, Er(OH)₃, Eu(OH)₃, Y(OH)₃; and zirconium phosphates.

### Yttrium Oxide/Chemical-Mechanical Planarization

Reduction in feature dimension in integrated circuits demands a high degree of flatness after chemical mechanical polishing. Yttrium oxide (Y₂O₃) nanosheets can act as slurry abrasives for CMP of copper. A hydrothermal method was used to synthesize multi-phase yttrium oxide (Y₂O₃) nanosheets (NS). Results showed that the global planarization was improved by 30% using a slurry containing Y₂O₃ nanosheets in comparison with a standard industrial slurry. During CMP, the two-dimensional square shaped Y₂O₃ nanosheet is believed to induce the low friction, the better rheological performance, and the laminar flow leading to the decrease in the WIWNU, surface roughness, as well as dishing. Dishing is the difference in height between the center of a portion of the wafer and the point where a portion of the wafer levels off. Dishing is the difference between the low point and a high point of the wafer. Dishing occurs when, during CMP, the polishing pad removes more material in one location than another. The application of the two-dimensional nanosheets as an abrasive in CMP would increase the manufacturing yield of integrated circuits.

CMP is a major process step for manufacturing integrated circuits. Significant effort has been made in developing new and effective slurries. To date, global planarization remains to be a major concern, particularly for patterned wafers where the metal/dielectric density differs across the wafer. The limitation of ion and slurry transfer is one of the key factors affecting planarization. The planarization is characterized by the WIWNU. Previous planarization studies have been focused on optimization of polishing parameters and utilization of corrosion inhibitors.

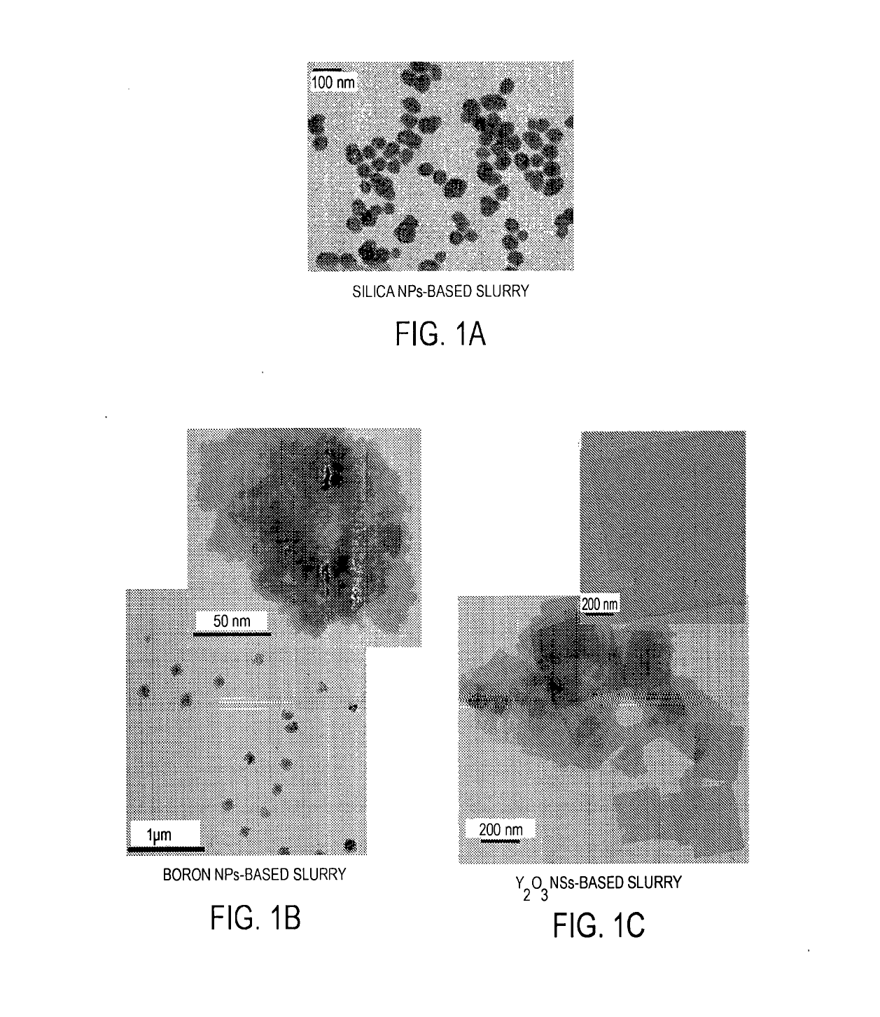

Two-dimensional Y₂O₃ NS abrasives provide a solution to improve the wafer planarization during CMP. A commercial colloidal silica (SiO₂) slurry (FIG. 1A) was used and the mechanism of planarization was studied via friction performances and dynamic behaviors under a fluid shear. Use of boron oxide NPs (FIG. 1B) increased the materials removal rate during copper (Cu) CMP. A CMP slurry containing yttrium oxide (Y₂O₃) NS (FIG. 1C) as abrasives provided an improvement in planarization.

Planarization performances in Cu CMP using different slurries were examined and compared. A Y₂O₃ NS-based slurry achieves the best planarization during CMP due to the uniform distribution of down force. The target substrates for CMP were Cu film-coated Si wafers (Ø 300 mm) (2 μm in thickness). The hydro-dynamical contact abrasion and the laminar slurry flow in Y₂O₃ NS-based slurry lead to decreased wafer non-uniformity and surface roughness. The localized pad deformation and the soft landing of the wafer are reasons that cause reduction of Cu dishing. The CMP application of rare earth nanomaterials benefits the development of microelectronic processing. The reciprocation of the carrier is taken into account. The slurry composition comprises 0.01 M Citric acid, 3Vol % H₂O₂, 3 wt % abrasive particles, and 0.05 wt % BTA in DI Water at pH: 5 (adjusted by 1 M of KOH).

### Lubricant

Nanoparticles, such as yttrium oxide or zirconium phosphate, can be used as additives in lubricant to provide an enhanced lubricant Enhanced lubricants reduce friction and wear. Nanomaterials are beneficial as additives in a lubricant for reasons including, but not limited to, nanomaterials have a high surface area to volume ratio, a layered structure, high load bearing capability and various synthesis techniques. A nanosphere has a point of contact and a nanosheet has a planar contact. Different shapes of Y₂O₃ are achieved from elevated temperature during synthesis. Shapes of Y₂O₃ can include nanosheets, nanoparticles, and nanowires.

Various additives have been developed to improve properties and performance of engineering systems. The additives have been used to eliminate wear, improve efficiency, reduce heat generation, and increase energy savings. The functionalization of additives includes deposit control, film-forming, anti-wear, anti-corrosion, friction reduction, and viscosity-modification. In terms of fluid lubrication, viscosity is one of the most important parameters to define the thickness of a lubricant film. Viscosity-modification additives can be used to improve viscosity-temperature properties of lubricants. Oil soluble polymers, such as olefin copolymers, polyisobutylene, hydro-generated styrene-isoprene (or butadiene) copolymers, polymethacrylates, and pour point depressants, have been used as viscosity modifiers. Such viscosity-temperature additives have two functions: polymeric additives expand with increasing temperature to counteract the oil thinning; organic molecules enable the lubricant to flow at low temperature via interlocking reduction through wax crystal modification. Adding Y₂O₃ improves global planarization in CMP of copper. The improvement can be due to the low-friction polishing process with stable shear.

The rheology of colloidal suspensions began with work performed by Einstein on the prediction of the viscosity of hard-sphere suspensions at low particle concentrations. While Einstein's relationship has been extensively studied experimentally, theoretically, and through computational simulations, the addition of nanoparticles (NP), in particular nanosheets, can affect the viscosity of a fluid in ways that do not follow Einstein's model. Specifically, Einstein's theory only permits the viscosity of a suspension to increase with the addition of particulates, while certain experiments show that the viscosity can be made to decrease. Coupling experimental rheological results, namely the relationship between shear rate and viscosity, the computational model can determine local shear rates. The local shear rates can then be used to determine a local viscosity based on the empirical data. This local viscosity is then used in the general Navier-Stokes equations to provide the overall motion of the non-Newtonian fluid matrix.

In investigating the effects of two-dimensional nanoparticles on fluid viscosity, simulation results were compared with the experimental data for Y₂O₃ nanomaterials diffused in a non-Newtonian (pseudoplastic) fluid matrix of mineral oil. The model was first validated by calculating the viscosity of pure mineral oil and comparing that to experimental results. Using the same model, rigid nanoparticles, nanosheets, and nanowires were added to the fluid to see their effects on the total viscosity. These numerical results are also compared to the experiment. Y₂O₃ NS were found to be an effective lubricant additive because of its unique 2D nanostructure. Viscosity measurements and fluid dynamic modeling addressed the origin of the enhanced lubricating performance 2D NS-like nanostructure provides an innovative lubricant additive that can optimize dynamic behavior of the lubricant fluid. Novel sheet-like 2D nanostructures of Y₂O₃ are an effective lubricant additive. The improvement in lubrication and reduction in viscosity were observed in mineral oil in the presence of Y₂O₃ NS. 0.1 wt % of the Y₂O₃ NS additive was capable of reducing friction and viscosity as much as by ˜40% and ˜5%, respectively. Particle hydrodynamics-based fluid dynamic simulation confirms the reduction in viscosity and inclined alignment of the Y₂O₃ NS in an ordered manner. The reduction of the viscosity can be understood by analyzing the decrease in shear stress, which is majorly dependent on Brownian stress and hydrodynamic stress. Based on viscosity modification by Y₂O₃ NS, the rheological properties of other 2D nanostructured suspensions can be useful in including, but not limited to, organic manufacturing, oil production and transportation, bioengineering, food processing, and pharmaceuticals.

Nanoparticle additives can improve the mechanical and transport phenomena of various liquids. Experimental results, coupled with generalized Smoothed-Particle Hydrodynamics simulations, provide insight into the mechanism behind this reduction of fluid shear stress. The ordered inclination of these two-dimensional nanoparticle additives markedly improves the lubricating properties of the mineral oil, ultimately reducing the friction, and providing a novel way in designing and understanding next generation of lubricants.

Friction and wear dominate the efficiency, energy consumption, heat generation, and lifetime of machinery. In a passenger car, for example, one-third of the fuel energy is used to overcome friction in the brakes, engine, tires, and transmission. Various additives have been reported to improve the properties and performance of lubricants. The function of additives includes deposit control, film-forming, anti-wear, corrosion resistance, and viscosity modification.

For fluid lubrication, viscosity is one of the most important parameters that define the thickness of a lubricant film and its shear stress. Viscosity is the measure of the resistance of a fluid under shear. It is expected that additives would affect the shear stress and fluid drag leading to the change in viscosity. Oil-soluble-polymer-based-viscosity-modification additives have been used to improve the viscosity-temperature performance of lubricants. Such polymer-based additives are not ideal for viscosity modification when lubricants are operated at a fixed temperature. Yttrium oxide nanosheets provide a solution to improve lubrication under isothermal operation.

Nanomaterial-based additives provide enhanced lubricating efficiency. The two-dimensional (2D) nanocrystals were studied as solid lubricants. The 2D nanostructured materials have layered structures. Within each atomic layer, the atoms are covalently bonded. In between those layers, van der Waals interactions are present. The 2D nanomaterials can be used as additives in liquid lubricants. The main function is film-forming. 2D nanostructured fluid additive, Y₂O₃ NS, improve global planarization in CMP of copper wafers. In one embodiment, this is due to low-friction polishing process with stable shear. In an embodiment, the 2D NS additive is able to reduce friction via modifying a lubricant's fluid dynamics. Novel sheet-like 2D nanoparticles of Y₂O₃ are an effective lubricant additive. Smoothed-Particle Hydrodynamics-based fluid dynamic simulation was consistent with the experimental results. Results revealed the inclination of the nanosheet particles toward the direction of flow.

### Zirconium Phosphate/Lubricant

Pseudo-two dimensional (2D) nanostructured α-zirconium phosphates (ZrP) affect lubrication. Tribological characterization revealed that the nanoplatelets were effective additives in non-aqueous and aqueous lubricants. Friction was reduced as much as 65% and 91%, in mineral oil and water respectively when ZrP nanoplatelets were added. Two mechanisms of friction are, intermolecular interaction and viscosity modification. Reducing energy loss due to friction reduction can benefit many sectors such as manufacturing and consumer automobiles as well as enable design of new materials.

Nanomaterial additives improve lubricating performance. The two dimensional (2D) nanomaterials that are van der Waals-bonded can act as solid lubricants and film-forming additives for lubricants. The existing tribological applications of 2D nanomaterials have been found in graphite and its derivatives, hexagonal boron nitride (h-BN), and transition metal dichalcogenides. The weak van der Waals force between adjacent atomic layers enables them to be exfoliated under a shearing force while in a lubricant. As such those nano-additives are effective in boundary and mixed lubrications. Low surface energy of the basal planes after exfoliation can limit their applications in hydrodynamic lubrication. This is due to their poor intermolecular interactions with lubricants. There are many alternative materials possessing 2D nanostructured features, e.g. oxides, hydroxides, nitrides, carbides, and phosphates. These materials have relatively strong inter-atomic-layer bonding that makes them difficult to be exfoliated. The high surface energy enables the edges and the dangling bonds of the basal planes to be passivated by the environment, i.e. lubricant molecules. It is useful to use certain types of 2D nanostructured materials as lubricant additives. Montmorillonite-like zirconium phosphates (either α-ZrP or γ-ZrP) is such a pseudo 2D nanostructured compounds with high surface energy. α-ZrP nanoplatelets can act as lubricant additives. α-ZrP [Zr(HPO₄)₂.H₂O] nanoplatelets can act as viscosity modifier in non-aqueous and aqueous lubricants.

The viscosity of a fluid is used to describe the resistance of relative movement between flow-layers. The viscosity of a lubricant determines its performance in friction reduction. When solid additives are added into a lubricant, fluid drag that acts on a solid surface affects the fluid viscosity and the hydrodynamic pressure. The shape of an additive affects the amount of fluid drag. The additives that align in the fluid direction could reduce the fluid drag. The 2D nanostructured materials can align in a fluid. In such the viscosity and friction can be used as indication for effective lubrication. The pseudo 2D α-ZrP nanoplatelets are utilized as lubricant (mineral oil and water) additives. The enhancement in the lubrication is found via modification of lubricants' rheological performance. Application of 2D nanoplatelets as viscosity modifiers reduces the friction-induced loss in liquid lubrication.

Three types of amines intercalated α-zirconium phosphate nanosheets with different interspaces. The amine intercalated α-zirconium phosphate nanosheets were synthesized and utilized as lubricant additives to mineral oil. Results from tribological experiments illustrated that these additives improved lubricating performance Results of rheological experiments showed that the viscosity of the mineral oil was effectively reduced with the addition of α-zirconium phosphate nanosheets. The two-dimensional structure, with a larger interspace, was better at in reducing viscosity. The nanosheet structure of α-zirconium phosphates is effective in friction reduction. The manufacture of lubricants with tailored viscosity is achieved by using different intercalators.

Friction and wear generate heat which later dissipates in the environment, leading to energy loss. In mechanical systems, the wasted energy due to friction and wear accounts for approximately 30% of the total energy consumed. Lubrication is a simple and effective method to reduce friction and wear. To improve the performance of lubricants, various additives, such as detergent additives, corrosion inhibiting additives, antioxidant additives, and viscosity modifiers can be utilized. For lubricants, viscosity determines the load carrying capacity in hydrodynamic lubrication, which is the most common lubrication state in rolling bearings, gears and pistons. Viscosity modifiers are usually added to adjust the viscosity of lubricants and to achieve a desired value. Others have reported that ethylene-vinyl acetate copolymer increased the viscosity of vegetable oil based lubricant by 330-420%. Researchers have added functionalized polymethacrylate copolymers in mineral oil as a viscosity modifier and found the film forming ability of the lubricant increased. Other oil soluble polymers have also been developed as additives to improve the flow properties and friction resistant behavior of lubricants.

Previous studies on viscosity modifiers mostly focused on polymer based materials. Research by the inventors demonstrated that two dimensional (2D) nanomaterials, such as yttrium oxide (Y₂O₃) and α-zirconium phosphate (α-ZrP) nanosheets, were able to change the viscosity when added into pure mineral oil. Lower viscosity is preferable in low temperature environment because high viscosity will generate inadequate lubrication due to slow flow of the lubricant. Some 2D structured materials like graphite and molybdenum disulfide have been well known for their excellent lubricating properties. These 2D structures are featured by loosely bonded layers. It largely reduces the frictional force of the interface due to the low shear strength between neighboring layers. On the other hand, the strong covalent or ionic bonds between the atoms in the same molecular layer are hard to break. These properties make the 2D nanostructures a promising candidate for lubricant additives.

α-zirconium phosphate with a nanosheet structure was synthesized and intercalated with amines. Intercalated α-ZrP affects the triobological and rheological properties of mineral oil. The viscosity of the mineral oil was reduced by these additives. The lubricating performance of the mineral oil was improved as well. The nanosheet structure can be useful in creating the next generation of lubricant additives.

Two dimensional α-zirconium phosphate nanosheets were synthesized and intercalated with ethylenediamine, propylamine, and butylamine resulting in different interlayer spacing from 0.9 nm to 1.7 nm. The nanosheets were added into mineral oil as lubricant additives. Results showed that the coefficient of friction was reduced visibly with the addition of the particles. Interestingly, the smaller the interlayer spacing, the more the friction reduction (about 50% at the concentration of 0.5 wt %) is obtained. This means that the strongest van der Walls forces of the smallest spacing are the most effective in friction reduction. In the rheological experiment, the most reduction in viscosity was found in butylamine intercalated α-ZrP. On the other hand, the sample with the smallest interspace shows best performance in friction reduction while that with the largest interspace is the best in viscosity reduction. The friction reduction at low speed/load region is related to the transportation of nanosheets into the contact area. At high speed/load region, the nanosheets contribute to decrease the resistance in the laminar flow.

Yttrium Oxide and Zirconium Phosphate as Lubricants

Lubricant is important in the action of a wind turbine. The top reasons for downtime in a wind turbine are 1) the gearbox, 2) the generator, and 3) the main bearing. A main reason of bearing failure in a wind turbine is improper lubrication. Lubricants can comprise base fluids and an additives package. The lubricant can be a liquid lubricant, gas lubricant, solid lubricant, or semi-liquid lubricant (grease). The liquid lubricant can be a base oil and additives. In an embodiment, the liquid lubricant can be used when there is a wide range of rotational speed (low rolling resistance) and a complex sealing device. In an embodiment, a gas lubricant can be used at a wide range of temperatures (about 200° C. to 2000° C.), at high working speeds, and it has a low load carrying capability. In an embodiment, a solid lubricant can be graphite/MoS₂, have a high load carrying capability, a low coefficient of friction, and a low working speed. In an embodiment, a semi-solid lubricant can be comprised of a base oil thickener, and additives, have a long working life span, have simple sealing, less leakage, and can be used at a low rotational speed.

Grease can comprise a base oil, a thickener, and additives. Grease additives can be corrosion inhibitors, friction modifiers, anti-wear additives, antioxidants, and extreme pressure additives.

In an embodiment, zirconium phosphate nanoplatelets can be 600 nanometers to 1 micrometer per side and 30 nanometers thick and can have a lamellar structure. The zirconium phosphate nanoplatelets can be exfoliated layer by layer due to hydrogen bonds. Different layer spacing can be achieved by intercalating with different materials. The zirconium phosphate additives have high thermal and chemical stability.

### EXAMPLES

### Example 1

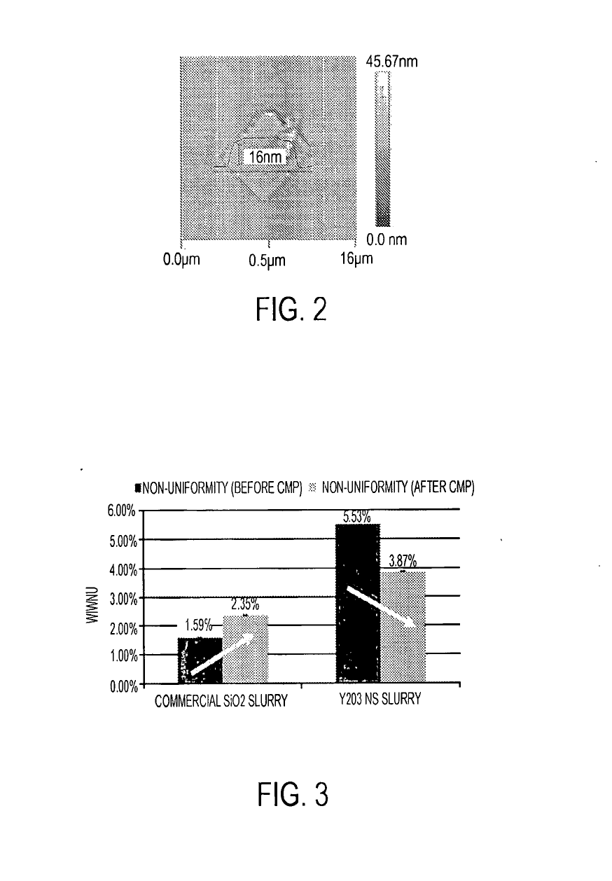

Citric acid, benzotriazole (BTA), and hydrogen peroxide (H₂O₂) used in this study were purchased from Sigma-Aldrich (USA) and were used without further purification. A home-made abrasive, Y₂O₃ NS (˜16 nm thick and >200 nm side)(FIG. 2) was used to prepare a CMP slurry. The Y₂O₃ NS was synthesized via a hydrothermal method. The home-made slurry was composed of citric acid (0.01 M), BTA (0.05 wt %), H₂O₂ (3 vol %), Y₂O₃ NS abrasive (3 wt %), and deionized (DI) water.

A commercial SiO₂ slurry (˜Ø 35 nm, Fujimi Corporation) was used as-received for comparison in CMP. Other SiO₂ NPs filtered from a commercial slurry (˜Ø 35 nm, Cabot Electronics Co.) with the same particle size and shape were used in friction and rheological experiments. Unwanted chemicals in the slurry were removed by filtering and rinsing with DI water for three times. The thoroughly rinsed SiO₂ NPs were collected after drying at 40° C. for 24 hrs for future friction and rheological experiments.

Cu film (2 μm thick) coated silicon (Si) wafers (Ø 300 mm) were used as target substrates for CMP experiments. These wafers were then used with an IKONIC™ polishing pad (Rohm & Haas).

### CMP Experiment and Characterizations

Polishing experiments were conducted using a Universal CMP Tester. Polishing was conducted for 1 minute. Wafers were placed face-down onto the polishing pad. The applied pressure was 1 psi (6894.757 Pa), and rotation speeds of the pad and the wafer were maintained at 79 rpm and 76 rpm, respectively. The speeds were kept close to each other for good uniformity in wafer planarization. Each slurry was used to polish four wafers.

Frictional behaviors and rheological properties of the slurry were examined. In order to solely investigate the frictional behaviors and rheological properties of SiO₂ NP and Y₂O₃ NS, the measurements were conducted in DI water. Friction experiments of Cu wafers were carried out using a tribometer (CSM Instruments). IC1000 polishing pads (Rohm & Haas) with SiO₂ (3 wt %) and Y₂O₃ (3 wt %) slurries were used in the friction experiments. Friction coefficients were recorded during each test for 60 cycles (20 mm per cycle, 20 mm/s) with an applied pressure of 80 kPa. An AR-G2 rheometer (TA Instruments) was used to measure the change of shear stress with shear rate ranging from 30 s⁻¹ to 500 s⁻¹. Three different concentrations were selected for the slurries in the rheological experiments, 0.3 wt %, 3 wt %, and 10 wt % in DI water. During the measurement, a stainless steel parallel spindle (Ø 25 mm) rotated while the lower Peltier plate was stationary. The gap (500 μm) between parallel plates was filled with slurries, and the temperature was maintained at 25° C.

The averaged thickness of the Cu film was measured using a table top four point probe (CDE ResMap 273) choosing 80 spots along the diameter of each wafer. The percentage ratio of the standard deviation of thickness relative to the averaged value was used to calculate the WIWNU. A surface profile topography system (KLA-Tencor HRP-350) was used to measure the surface roughness and the Cu dishing on Si wafers. Results of the WIWNU, the surface roughness, and the Cu dishing were presented statistically.

FIG. 1 depicts TEM and FIG. 2 depicts AFM images of multiphase Y₂O₃ NS synthesized at 120° C.

Results showed that a slurry containing 3 wt % Y₂O₃ NS could reduce the WIWNU for 30% whereas the commercial SiO₂ slurry increased WIWNU for 48%. FIG. 3 depicts the changes of the WIWNU before (dark) and after (light) CMP using different slurries.

Low dishing (17 Å) was obtained using Y₂O₃ slurry comparing to that commercial SiO₂ slurry (22 Å). This is due to the fact that the sheet-shaped nanoparticles promote a uniform contact pressure distribution at the interface between a pad and wafer. These nanosheets are believed to increase the laminate flow resulting in efficient slurry transport. In an embodiment, the slurry provides new approaches to develop slurries and it is beneficial in optimizing the manufacturing processes in microelectronics.

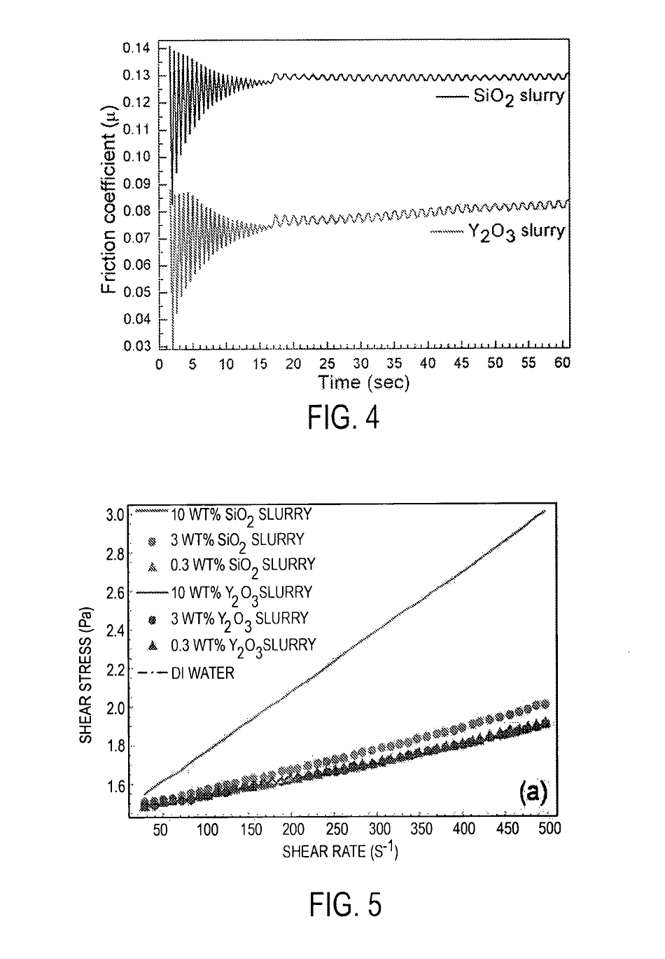

FIG. 4 depicts the results of friction between the Cu film and the polishing pad in SiO₂ (top) and Y₂O₃ (bottom) slurries.

FIG. 5 depicts the results of rheological measurements: FIG. 5 depicts the comparison of shear stress-shear rate plots in different slurries with different abrasive concentrations (10 wt %, 3 wt %, and 0.3 wt % for SiO₂ and Y₂O₃).

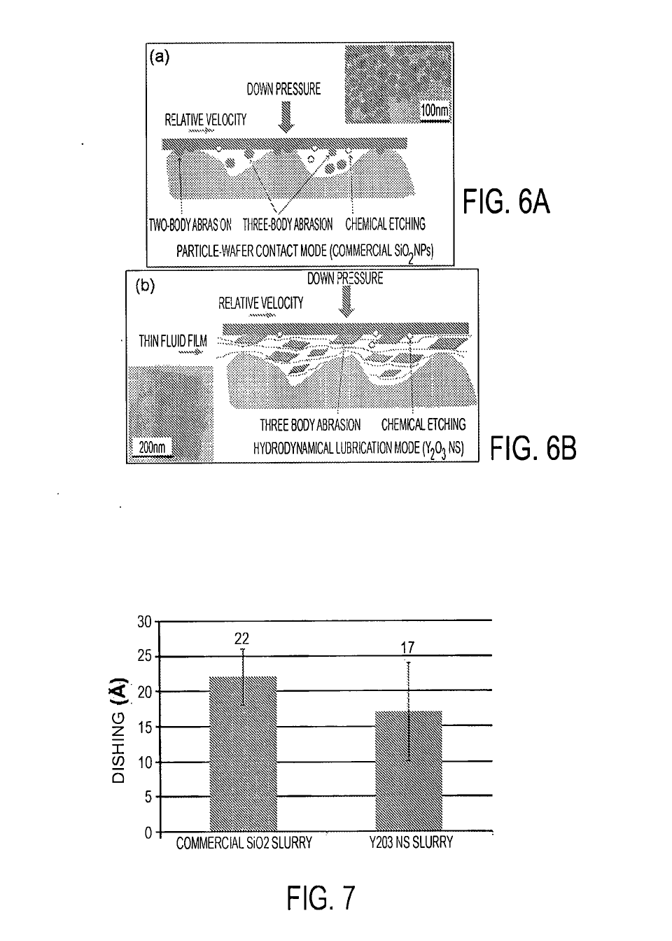

FIG. 6 depicts schematic representations of abrasion modes using (FIG. 6A) the commercial SiO₂ slurry and (FIG. 6B) the Y₂O₃ slurry.

FIG. 7 depicts the Cu dishing in wafers that are polished using a commercial SiO₂ or Y₂O₃ NS slurry.

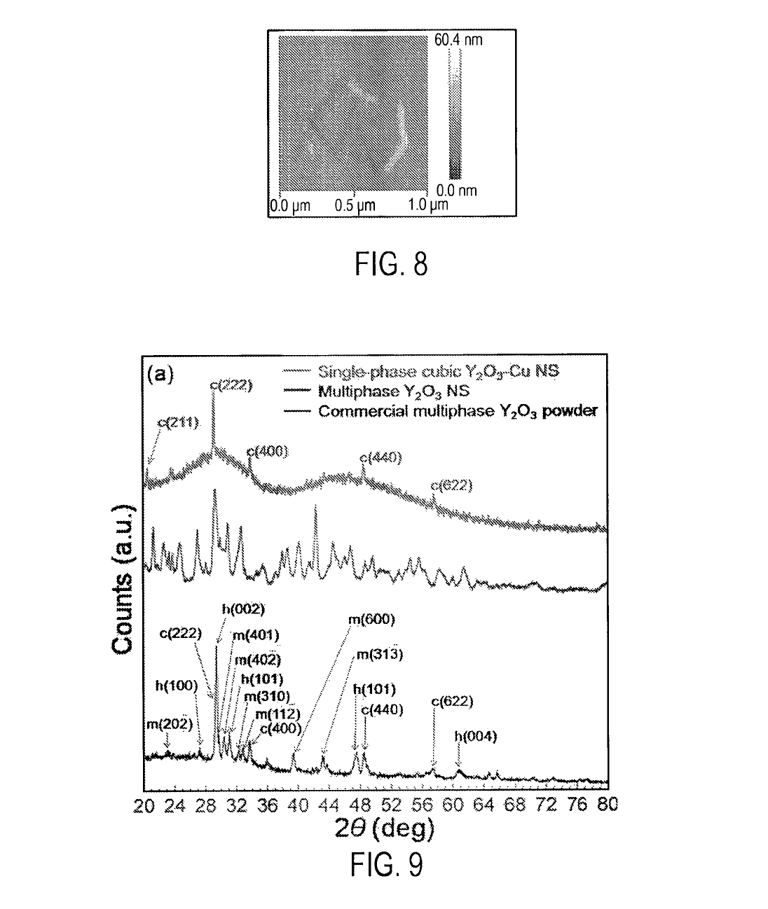

FIG. 8 depicts the AFM image of the multiphase Y₂O₃ nanosheets. XRD patterns were obtained and compared for the commercial multiphase Y₂O₃ powder (bottom pattern), the multiphase Y₂O₃ NS (middle pattern), and the single-phase cubic Y₂O₃—Cu NS (top pattern). (FIG. 9).

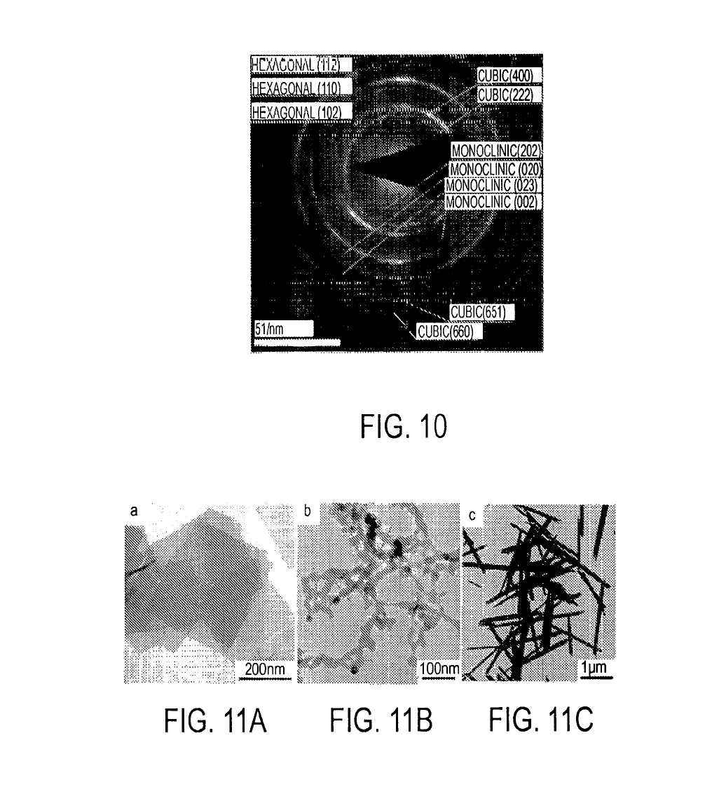

Selected area electron diffraction (SAED) patterns of multiphase Y₂O₃ NS are shown in FIG. 10.

TEM images of Y₂O₃ nanosheets (NS) (FIG. 11A); Y₂O₃ NP (FIG. 11B); and Y₂O₃ nanowires (NW) (FIG. 11C) were obtained.

The comparison of WIWNU before and after CMP experiments in different slurries is shown in FIG. 3. The trend in the WIWNU after CMP is indicated by arrows. The WIWNU is reduced by 30 percent using the Y₂O₃ slurry. Using the commercial SiO₂ slurry shows an increase in the WIWNU by 48 percent. Meanwhile, the wafer polished using the Y₂O₃ slurry has better surface quality than when the SiO₂ slurry is used. To understand the effects of abrasives on WIWNU and surface roughness, frictional and rheological results are shown in FIG. 4 and FIG. 5, respectively. In FIG. 4, it is observed that the Y₂O₃ slurry has lower friction coefficient than the SiO₂ slurry. In FIG. 5 it is clear that the SiO₂ slurry with higher concentration has the larger slope in shear stress-shear rate plots. With the increase in SiO₂ concentration, the slurry becomes more viscous. Viscosity is directly related to the friction and mass transfer among fluid layers. The change in slope of the shear stress-rate plots implies movement of one fluid layer respect to another with significant mass transfer. This is the evidence of a turbulent flow. It is concluded from rheological measurements that SiO₂ NPs increases the viscosity of slurries while Y₂O₃ NS shows no effects.

Based on frictional behaviors and rheological properties of slurries, mechanisms in reduction of WIWNU are proposed in schemes illustrated in FIG. 6. When the wafer is polished using the SiO₂ slurry, spherical NPs (see inset of FIG. 6A can embed in the wafer and abrade it through particle-wafer contact mode (FIG. 6A). Such abrasion through 3-body and 2-body wear is believed to be responsible for materials removal in CMP. On the contrary, when square Y₂O₃ NS (see inset of FIG. 6B) is used, the NS have larger contact area. The increased contact leads to a uniform distribution of the down force and the reduced contact pressure. When the applied pressure is low, a fluid film will be able to form between the pad and wafer (FIG. 6B). As a result, the uniformed contact and improved slurry transport lead to more effective lubrication. This is confirmed by the friction results. Accordingly, polishing under lubricative conditions can reduce the WIWNU after CMP. In addition, when slurries entered the interface between the pad and wafer, Y₂O₃ NS can be deemed to form parallel layers whereas SiO₂ NPs distribute chaotically and stochastically. As demonstrated by rheological experiments (FIG. 5), a laminar flow and a turbulent flow were believed to form in Y₂O₃ and SiO₂ slurries, respectively. A laminar slurry flow that has low viscosity with little flow fluctuation leads to uniform distributions of relative velocity and abrasive movement trajectories. As such the WIWNU is decreased.

In microelectronic devices, an important factor to planarize a wafer is elimination of Cu dishing. Results of Cu dishing in CMP are shown in FIG. 7. Wafers polished with the Y₂O₃ slurry obtained less dishing than that polished with the SiO₂ slurry. During CMP, the protruded areas were polished while the low areas were passivated resulting in a smooth surface. Localized pad deformation occurs and has been reported to be an important reason causing metal dishing. In the current work, however, Y₂O₃ NS has larger contact area than SiO₂ NPs. The down force distributes uniformly in the contact area. The low area undertakes a comparable pressure to that protruded area experiences. A uniform pressure distribution is beneficial for reduction in dishing. In addition, dishing can be reduced through gentle contacts of pad through Y₂O₃ NS to the wafer, which is similar to a soft landing in abrasive free polishing. The CMP conducted using the Y₂O₃ slurry obtained little dishing.

### Example 2

### Synthesis Procedure of the Nanosheets

Nanosheets were synthesized by dissolving 0.4 g commercial Y₂O₃ powder in 80 mL HNO₃ solution (2.4 wt %) at 50° C. to form a clear and transparent yttrium nitrate [Y(NO₃)₃] solution. After adding 320 mL DI water, a KOH solution (15 wt %) was used to adjust the pH value of the mixed solution rapidly to 8.7. White Y(OH)₃ floc appeared as soon as the KOH was added to the Y(NO₃)₃ solution. DI water was added to the turbid solution up to 600 mL, stirred for 10 min, and transferred into a 2 L general purpose non-stirred pressure vessel (4622Q, Parr Instrument). The vessel was sealed and heated at 120° C. for 12 hours. The as-synthesized Y₂O₃ nanosheets were collected after cooling the vessel to room temperature. Possible unwanted ionic remnants were removed by rinsing with a large volume of DI water. The synthesized Y₂O₃ nanosheets were dried in air at 70° C. for 24 hours after filtration.

Directly hydrothermal-synthesized Y₂O₃ NS is multiphase. The reaction between water and Y₂O₃ powder occurs spontaneously via hydrolysis in the nitrate solution. This reaction leads to the formation of hydroxide and oxide-hydroxide.

### Example 3

Most metal hydroxide and oxide-hydroxide have layered structures. Exfoliation of the layered structures results in the formation of hydroxide or oxide-hydroxide NS initially. Y₂O₃ NS is obtained hydrothermally via subsequent dehydration of the hydroxide and oxide-hydroxide in the high-boiling solution. Due to the random distribution of two-dimensional growth orientations, multiphase Y₂O₃ NS will contain cubic, hexagonal, and monoclinic crystalline structures.

### Example 4

The heavy mineral oil and Y₂O₃ NP were purchased from Sigma-Aldrich (USA) and were used without further purification. Two hydrothermal synthesized nanomaterials, Y₂O₃ NS and Y₂O₃ nanowires (NW), were used.

Characterization of Y₂O₃ NS and Frictional and Rheological Measurements

A transmission electron microscope (TEM, JEOL 1200, and accelerating voltage at 100 kV) was used to image Y₂O₃ NP, NW, and NS. The coefficient of friction was recorded using a tribometer (CSM Instruments). The tribological measurements were carried out via a pin-on-disk configuration that consisted of a rotating disk (glass slide) and a fixed pin (steel ball), 100 μL of lubricant liquid filled in between them, and the rotational radius was set at 3 mm. In order to plot Stribeck curves, rotational speeds varied from 10 rpm to 600 rpm, and four different forces, 1 N, 0.5 N, 0.25 N, and 0.15 N, were loaded during the testing. Coefficient of friction at specific speed and load was recorded. During each test, coefficients of friction were recorded for 1 minute, and the averaged friction coefficients were used in plotting the Stribeck. The Viscosity was measured using an AR-G2 rheometer (TA Instruments), varying the shear rate from 10 s⁻¹ to 18740 s⁻¹.

During the measurements, a stainless steel parallel spindle (Ø 25 mm) rotated while the lower Peltier plate was stationary. The gap (200 μm) between parallel plates was filled with the lubricant liquid, and the temperature was maintained at 25° C. Thixotropic behaviors were also investigated by applying a constant shear rate (10000 s⁻¹) to the lubricants for 10 minutes, and the changes of the viscosity with time were tracked.

Roles of Y₂O₃ NS Additives in Mineral Oil

Particle hydrodynamics-based fluid dynamic simulation was used to confirm the thixotropic findings. A viscosity decrease (namely, reduced friction) was caused by the Y₂O₃ NS and a viscosity increase was caused by the Y₂O₃ NP. Due to the unique 2D structure, the Y₂O₃ NS is capable of aligning along the flow direction. It is interesting to see that the viscosity was reduced most significantly when the Y₂O₃ NS was inclined with respect to the flow. An 8 degree inclination angle results in more viscosity reduction than a 6 degree inclination angle. Having the Y₂O₃ NS oriented directly parallel to the flow, a slight increase in viscosity with respect to that of pure mineral oil is obtained. The inclined alignment of square Y₂O₃ NS in an ordered manner is believed to present with lubricant shearing.

The inclination of Y₂O₃ NS is able to separate lubricant flow layer by laminar cutting, leading to decreasing in the dynamic interaction (including momentum transfer) between them. As a consequence, the laminar separation-induced reduction in fluid drag is obtained. On the contrary, Y₂O₃ NPs can flow in the direction of lubricant fluid, but fail to organize themselves in the mineral oil. Inertial forces-driven movement of them results in increase of viscosity.

Therefore, the viscosity modification-induced enhanced lubrication can be well understood by inclined alignment of the ordered Y₂O₃ NS in mineral oil under shear. The simulation results can be capitalized to provide insight as to why the Y₂O₃ NS additives affect the shear behavior and the enhanced lubrication. Viscosity used in this paper is dynamic (shear) viscosity, defining as ratio of shear stress to shear rate. Smaller shear stress at a specific shear rate means the smaller viscosity. Shear stress can be represented by three contributions: an interaction stress component, a Brownian stress component, and a hydrodynamic stress component. For a hard-particle system, the interaction stress is zero.

The random fluctuation of nanomaterials' positions in a liquid suspension results in the Brownian stress. As the ordered alignment of the Y₂O₃ NS would significantly reduce the chance of the random movement, its Brownian stress is smaller than that of random Y₂O₃ NP under shearing. On the other hand, hydrodynamic stress is caused by delay of dispersed particle's motion with respect to the increase of shear strain. During the alignment in the lubricant, that phenomenon that Y₂O₃ NS inclines to certain degree is believed to shrink the timescale needed to catch up the shear strain, and reduce the hydrodynamic stress. Little organized Y₂O₃ NP in lubricant is unable to keep up with the shear strain increase and leads to a high viscosity. Stokesian dynamics simulations of hard particle suspensions indicated that alignment of the suspended particle pair is the dominant mechanism underlying shear thinning. In the Y₂O₃ NS dispersed mineral oil, the aligned pairs of 2D nanostructure would facilitate the reduction in shear stress further. On the whole, inclined ordered alignment of Y₂O₃ NS is able to reduce the shear stress when flowing along the lubricant. The shearing-induced viscosity reduction is the origin that Y₂O₃ NS additives can eliminate the friction from boundary lubrication through hydrodynamic lubrication.

### Example 5

In order to investigate the fluidic modification due to the NS additives, computational simulations were performed in which a non-Newtonian fluid is modeled utilizing smoothed-particle hydrodynamics (SPH) with the addition of rigid body inclusions. Coupling experimental rheological results with the computational modeling addresses the origin of the enhanced lubricating performance via viscosity modification. Such novel findings will shed new light in research in 2D nanostructured particles and their fluidic behavior. The 2D NS-like particles provide an alternative option in developing innovative additives to optimize the dynamic behavior of a liquid lubricant.

Hydrothermal synthesized Y₂O₃ NS were characterized. The effective lubricants consisted of a base lubricant oil (mineral oil) and additives (Y₂O₃ NS), and the additives with different concentrations (1 wt %, 0.5 wt %, and 0.1 wt %) were simply dispersed in the mineral oil via ultrasonication for 15 minutes before the measurements. A transmission electron microscope (TEM) was used to image the Y₂O₃ NS. The coefficient of friction was evaluated using a tribometer with pin-on-disk configuration. It consisted of a rotating disk (glass slide) and a fixed E52100 steel ball (Ø 6.35 mm). The lubricant of 100 μL was used and the rotational radius was set at 3 mm. In order to plot Stribeck curves, rotational speeds varied from 10 rpm to 600 rpm under four different applied loads: 1N, 0.5 N, 0.25 N, and 0.15 N. The averaged friction coefficients were used to plot Stribeck curves.

In order to understand the fluid behavior, modeling was conducted using SPH. The goal is to determine the total viscosity of the composite fluid matrix with a single inclusion of Y₂O₃ NS corresponding to the same volume fraction in experiment. The fluid model is capable of having a spatially dependent shear viscosity. Coupling experimental rheological results, namely the relationship between shear rate and viscosity, the computational model can determine a local viscosity by utilizing the experimental data after calculation of the shear rate. This local viscosity is then used in the general Navier-Stokes equations to provide the overall motion of the non-Newtonian fluid matrix. The flow field of the surrounding lubricant interacts with the NS causing it rotates with an angular velocity when translating in the lubricant. The initial position and angle of inclination were prescribed during simulation. The subsequent position and motion were dictated by the flow-field interaction with NS. The simulation was run until the calculated effective viscosity reached a steady state. A stress tensor was then calculated for the composite fluid to ultimately calculate the viscosity of the lubricant (by dividing the stress tensor with the shear rate). The modeling domain consisted of a rectangular shear cell with periodic boundary conditions in all directions except the vertical. To apply a constant rate of strain at the boundaries in the vertical direction, Lees-Edwards Allen and Tildesley boundary conditions were utilized. Finally, to contain the particles in the vertical direction, a repulsion force was used similar to a Lennard-Jones potential utilized in molecular dynamic (MD) simulations. The fluid viscosity was subsequently calculated using colloidal rheology calculations.

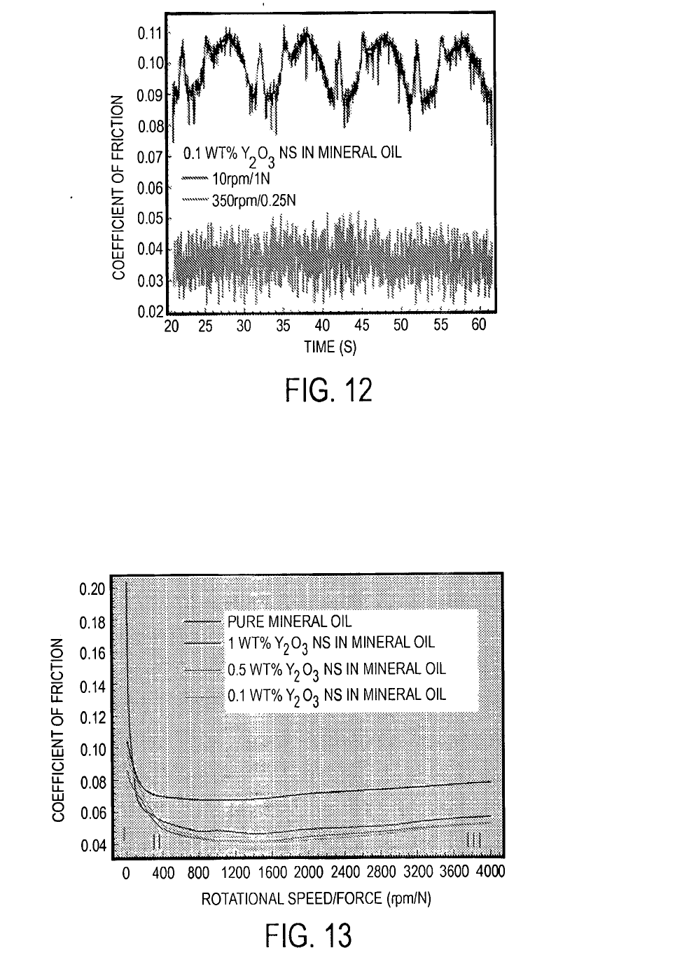

FIG. 12 depicts a comparison of friction coefficient between boundary lubrication (top plot) and hydrodynamic lubrication (bottom plot) using the mineral oil containing 0.1 wt % of Y₂O₃ NS additives under different lubricating parameters. FIG. 12 showed an example comparison between boundary lubrication (top black plot) and hydrodynamic lubrication (bottom dark green plot) using mineral oil with 0.1 wt % Y₂O₃ NS additives under different frictional parameters.

FIG. 13. Stribeck curves of mineral oil (top plot), and with addition of 1 wt % (second from top plot), 0.5 wt % (second from bottom plot) and 0.1 wt % (bottom plot) Y₂O₃ NS additives. The coefficient of friction or the thickness of the fluid film determined the lubrication regime as labeled in FIG. 13. They were boundary lubrication (regime I with very high friction) under high load and at low speed, mixed lubrication (regime II, experiencing continuous reduction in friction) when the load decreases and the speed increases, and hydrodynamic lubrication (regime III, with stable low friction) due to the significant low load and high speed.

The unique 2D nanostructure of Y₂O₃ NS made it an effective additive in enhancing lubrication of the mineral oil. As shown in FIG. 13, lubricating performance of mineral oil containing different concentrations (1 wt %, 0.5 wt %, and 0.1 wt %) of Y₂O₃ NS were examined. The low concentration of Y₂O₃ NS additives led to reduction in friction. At a concentration of 0.1 wt %, the Y₂O₃ NS additive decreased the coefficient of friction as much as by ˜40%. A small amount of Y₂O₃ NS additive was enough to greatly improve lubricating performance in all regimes, from the boundary lubrication regime (I) to hydrodynamic lubrication regime (III). For the lubricant with relatively high concentration (1 wt %), a poor lubricating performance was observed in boundary lubrication (blue plot in regime I in FIG. 13), which showed significantly higher coefficient of friction than pure mineral oil. This could be due to agglomeration of Y₂O₃ NS under the high load and low rotational speed in the boundary lubrication regime. The fluid film of the mineral oil would be blocked as the excessive Y₂O₃ NS piled up. Direct contact between the Y₂O₃ nanosheets resulted in a significant frictional drag. When the rotation sped up and the load decreased, the agglomerated particles would be dispersed by the fluid shear. Once the lubrication became mixed or hydrodynamic, the Y₂O₃ NS additives improved the lubricating performance via modifying the fluid behavior.

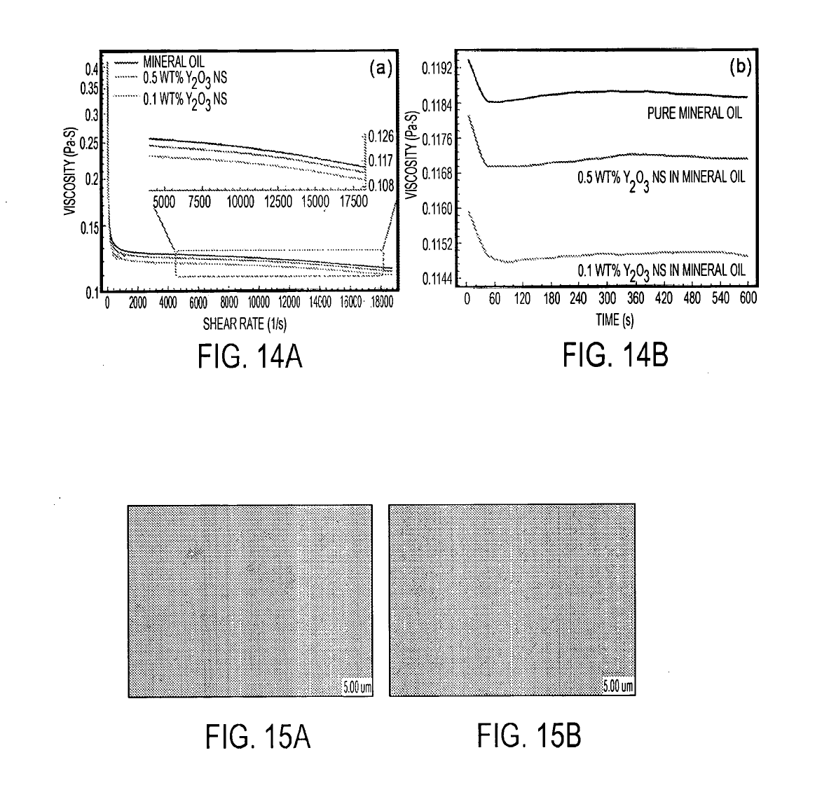

FIG. 14. (FIG. 14A) Variation of viscosity with shear rate in mineral oil (top plot), and with addition of 0.5 wt % (middle plot) and 0.1 wt % (bottom plot) Y₂O₃ NS additives. (FIG. 14B). Reduction in viscosity of mineral oil (top plot) in the presence of Y₂O₃ NS with concentrations of 0.5 wt % (middle plot) and 0.1 wt % (bottom plot) under a constant shear rate (10000 s⁻¹). To further understand the effects of 2D nanoparticles on friction reduction, the viscosity of lubricants was examined According to Reynolds' theory, once a continued lubricant film is formed between two bodies in relative motion, a hydrodynamic pressure is built up to separate the two surfaces. The viscosity of the fluid under pressure is a critical parameter that determinates the thickness and performance of a lubricant film. The viscosity against shear rate was measured, as shown in FIG. 14A. Corresponding to the Stribeck curves (FIG. 13), a low viscosity was obtained once Y₂O₃ NS additives were added into the mineral oil. By decreasing the concentration of the Y₂O₃ NS, the viscosity was reduced further (FIG. 14A). At the concentration of 0.1 wt %, Y₂O₃ NS could reduce the viscosity as much as by ˜5%. The reduction of both viscosity and CoF by the Y₂O₃ NS additives implied that the nanosheets had the capability of improving lubrication via modification of the lubricants' rheological property.

The viscosity reduction with increasing shear rate indicated the shear thinning characteristic of the lubricants. To further understand this phenomenon, a thixotropic study was conducted to investigate the shear thinning properties of mineral oil lubricants with Y₂O₃ NS additives. The results were shown in FIG. 14B. By applying a constant shear rate, the fluid structure was deconstructed initially that led to the quick drop of viscosity at the beginning (<60 s). As mineral oil was composed of long-chain alkane molecules, the physical interactions between them enabled the deconstructed structure to rebuild continuously. The process that broke the molecular structures (shearing) competed with physcial interactions that allowed molecular bonding. The dynamic balance between them resulted in a relatively stable viscosity value in time in the later stage (>60 s). From FIG. 14B, Y₂O₃ NS additives were also found to reduce viscosity in the thixotropic study. The 0.1 wt % Y₂O₃ NS reduced the viscosity more than that of 0.5 wt % Y₂O₃ NS under the constant shear rate.

### Example 6

Y₂O₃ nanosheets (NS) influence lubrication when added to grease. Y₂O₃ NSs affect the frictional behavior of grease. There is critical concentration of NS. The CoF changes as a function of applied loads, speeds, and temperature. The effects on wear are described in terms of morphology and wear rate. The addition of Y₂O₃ NS affects galling resistance. The mechanisms of Y₂O₃ additives on lubrication of grease change based on the shape of nanoparticles.

Effects on Frictional Behavior of the Grease with Y₂O₃

In order to observe the frictional behavior of the grease with Y₂O₃, the CoF was determined with tribometer experiments. The CoF of the grease containing Y₂O₃ significantly decreased either at room temperature or high temperature. The change in the CoF over time was observed at room and high temperatures by tribometer experiments. Statistical analysis was performed to observe whether there was a difference between the reference grease and the grease with Y₂O₃.

Dispersion of Y₂O₃ in Grease

FIG. 15A-FIG. 15B depicts optical microscope images of the reference grease (left) and the grease with Y₂O₃ (right) at 1000× magnification. Uniformly distributed nanoparticles in grease are important for consistent performance. An optical microscope was used to observe the dispersion of Y₂O₃ NS in grease. FIG. 15A-FIG. 15B shows the optical microscope images of the grease without (FIG. 15A) and with (FIG. 15B) Y₂O₃. FIG. 15A indicates the reference grease and FIG. 15B is the image of the grease with 0.5 wt % Y₂O₃. In the case of the grease with 0.5 wt % Y₂O₃, there are many particles distributed uniformly. The proper dispersion of Y₂O₃ is a critical factor to ensure the effect of NS on lubrication of grease.

### Effects on Concentration

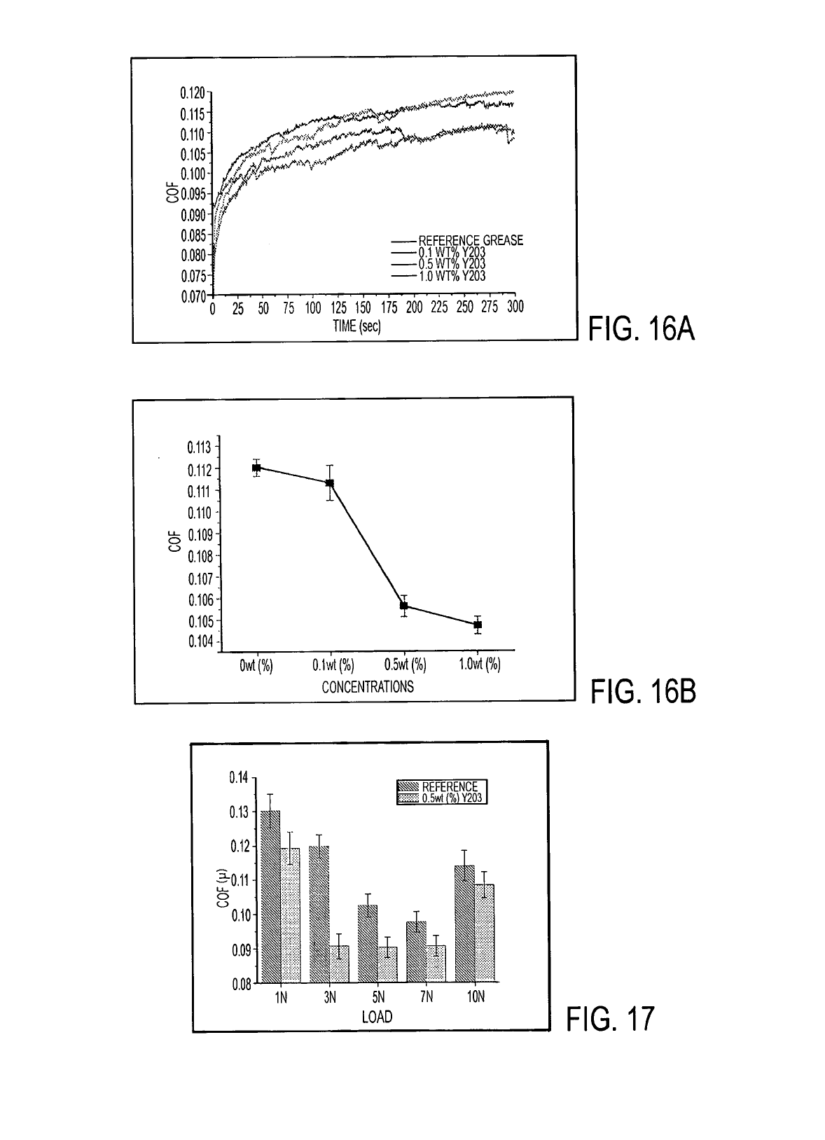

The concentration of additives in grease should be considered because grease usually consists of 0.5%˜10% additives. The CoF of 0.1 wt %, 0.5 wt %, and 1.0 wt % Y₂O₃ NS in grease was compared to observe the effect of concentration. As shown in FIG. 16A-FIG. 16B, the CoF was decreased with 0.5 wt % Y₂O₃ NS. However, the addition of 0.1 wt % of Y₂O₃ NS in grease did not show a change in the CoF. The addition of 0.5 wt % and 1.0 wt % of Y₂O₃ NS in grease showed 5.35% and 7.14% decrease of the CoF, respectively. This result shows that Y₂O₃ NS are acceptable as additives in grease because the small amounts of Y₂O₃ NS (less than 1.0 wt %) were enough to improve the frictional behavior (lubricating ability) of grease.

Effects of Y₂O₃ on Frictional Behavior of Grease at Room Temperature

For the comprehension of frictional behavior with Y₂O₃ NS, a pin-on-disc tribometer experiment was conducted at room temperature with the different loads and rotating speeds. The different friction responses were observed depending on the applied loads and speeds. FIG. 17 shows the comparison of the CoF under different loads. The CoF of the grease with 0.5 wt % Y₂O₃ NSs obviously decreased in all loads, when it compared to the reference grease. The decrease rates of the CoF between two samples are 8.4% under 1N, 24.4% under 3N, 11.9% under 5N, 7.2% under 7N, and 4.9% under 10N. On an average, the CoF showed 11.3% decrease with the addition of Y₂O₃ NSs in grease. This result can be explained with the rotating and sliding of Y₂O₃ NSs between two surfaces. The rotating and sliding motions contributed to the low shear stress and formed a thin physical film. Further analysis will be covered in the mechanism section.

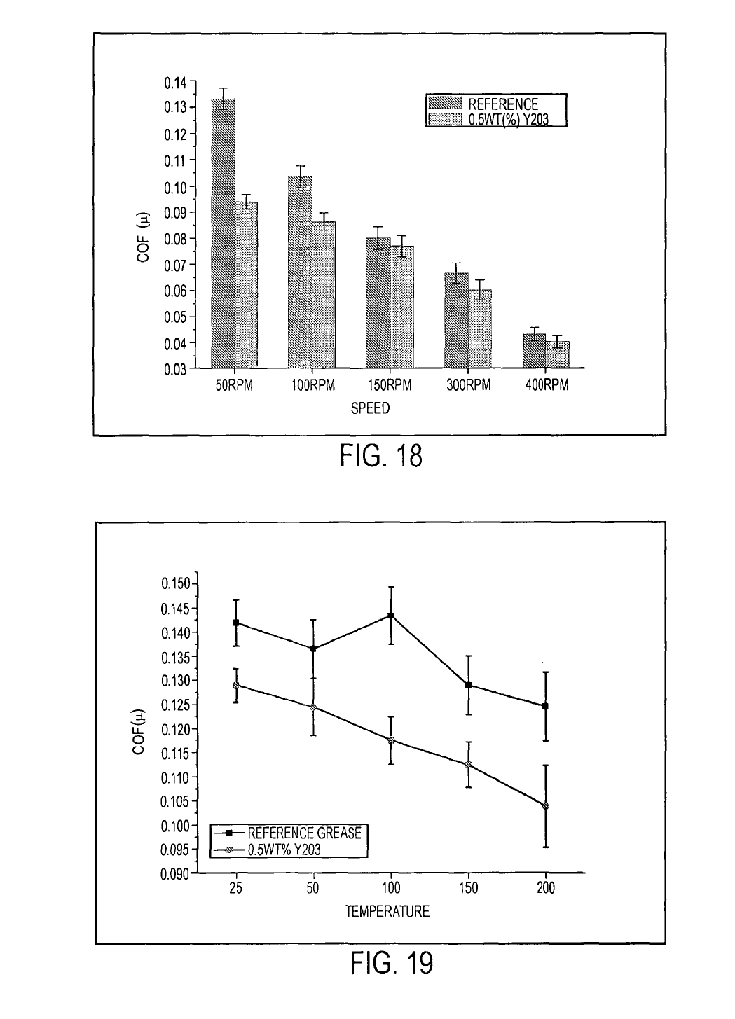

FIG. 18 shows the comparison of the CoF at different speeds. The significant decrease in CoF was only observed at low rotating speeds (<150 RPM). The decreased rates of the CoF of the grease samples with and without Y₂O₃ NSs are 29.5% at 50 RPM, 16.6% at 100 RPM, 3.7% at 150 RPM, 9.7% at 300 RPM, and 6.7% at 400 RPM, respectively. The results show that the rotating and sliding effects of Y₂O₃ NS enable at all rotating speeds.

In the frictional performance on lubrication of grease, the addition of Y₂O₃ NS shows the decrease of the CoF under different loads and at rotating speeds. These results can be explained with the opportunity for the decrease of friction with rotating and sliding of Y₂O₃ NS.

### Effects on Frictional Behavior at High Temperature

The working temperature of a wind turbine is estimated from −20° F. (−28.89° C.) to 300° F. (148° C.) depending on its service places such as sea and desert. For the potential application in a wind turbine, the addition of Y₂O₃ should show the enhanced performance on lubrication of grease at elevated temperatures.

The frictional behavior of grease was compared by determining the CoF at high temperature for reference grease and grease with 0.5 wt % Y₂O₃ NS. FIG. 19 shows the CoF of the reference grease and the grease with 0.5 wt % Y₂O₃ NS at elevated temperatures. The grease with 0.5 wt % Y₂O₃ NS consistently shows the lower CoF than the reference grease at 25° C., 50° C., 100° C., 150° C., and 200° C., respectively. The average decrease in CoF shows 13.1% with the addition of 0.5 wt % Y₂O₃ in grease. Both samples show a decrease in CoF at the highest temperatures. This phenomenon can be explained with the decreased viscosity of grease at a high temperature. This indicates that Y₂O₃ NS are thermally stable at high temperature. The thermal stability provided the opportunity for Y₂O₃ NS to be able to rotate and slide in the contact area. Similar to the experiment at room temperature, this phenomenon also reduced friction at high temperature.

### Effects on Wear

This section discusses about the wear resistance of grease that was significantly increased with the addition of Y₂O₃NS. The wear scar and the wear track of worn surfaces after pin-on-disc tribometer experiments were analyzed. The morphology of the wear scar and the wear track was characterized by optical microscope, interferometer and SEM.

### Analysis of Wear Scar and Wear Track on Worn Surfaces

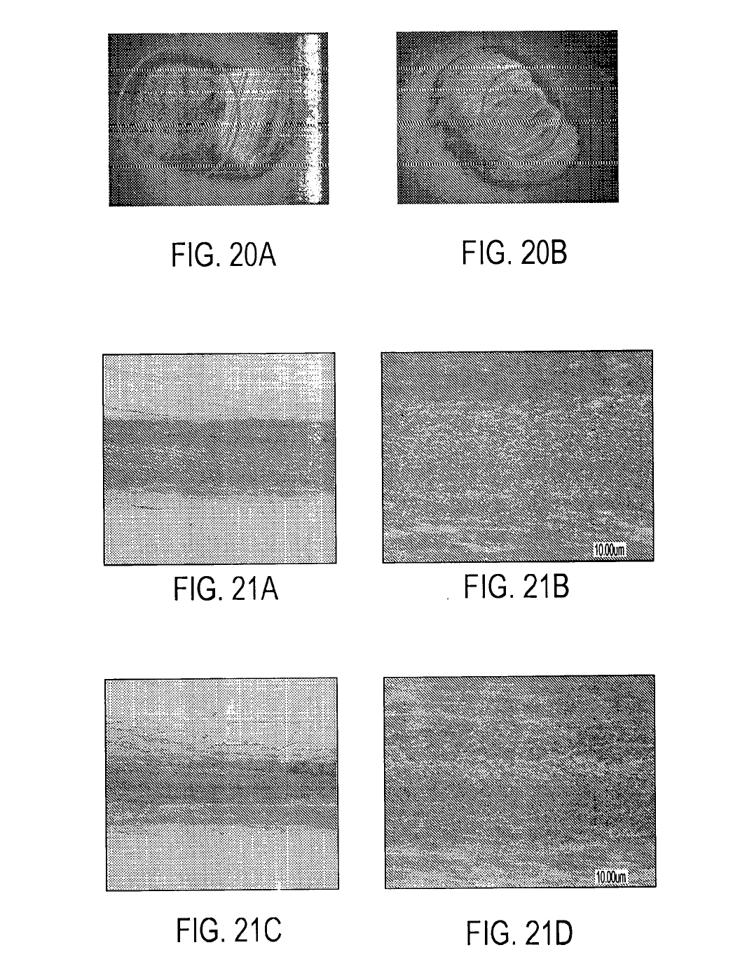

FIG. 20A-FIG. 20B depicts optical microscope images of the wear scar of the reference grease (FIG. 20A) and the grease with Y₂O₃ (FIG. 20B) at 200 times magnification. FIG. 20A-20B shows optical microscope (OM) images of the wear scar on ball bearings used in a pin-on-disc tribometer. FIG. 20A clearly shows a larger area of worn scar than FIG. 20B as marked with red circles. The reference grease developed a severe wear scar on the ball bearing, while the addition of Y₂O₃ NS in grease protected the ball bearing from developing a severe wear scar.

FIG. 21 depicts optical microscopy images of wear track of the reference grease (upper FIG. 21A, FIG. 21B) and the grease with Y₂O₃ (lower FIG. 21C-FIG. 21D) at 100 times (FIG. 21A, FIG. 21C) and 1000 times (FIG. 21B and FIG. 21D) magnification. FIG. 21A-FIG. 21D show the wear tracks of the reference grease and the grease with 0.5 wt % Y₂O₃ NS after a pin-on-disc tribometer experiment for 2 hours. In optical images, the dark color portion indicates the deformation of surfaces. When FIG. 21A and FIG. 21B are compared to FIG. 21C and FIG. 21D, the wear track of 0.5 wt % Y₂O₃ NS FIG. 21C and FIG. 21D show slightly the smaller dark portion than the reference grease. This means that the addition of Y₂O₃ NS protected the surface from the deformation caused by friction and heat. Interferometer results of wear depth on the reference grease and the grease with Y₂O₃ NS shows a narrow wear track for the grease with Y₂O₃.

### Analysis of Roughness on Worn Surface

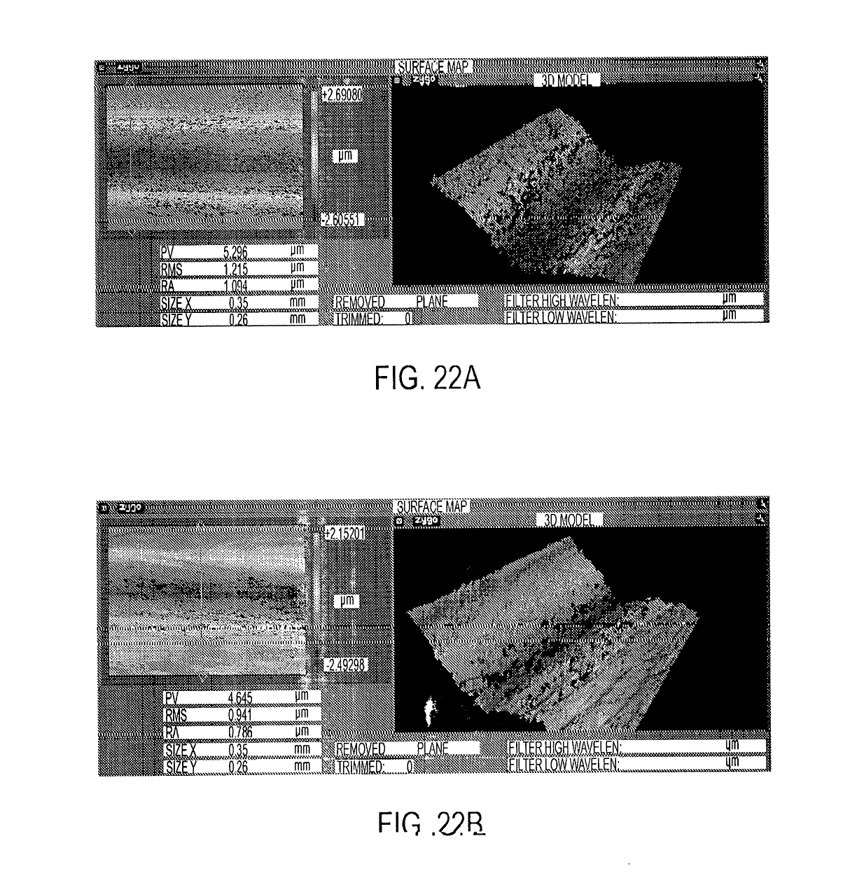

An interferometer was used for the analysis of the morphology of wear surface, including the roughness and the wear depth within a wear track. FIG. 22 depicts interferometer results on the grease without (FIG. 22A) and with Y₂O₃ NS (FIG. 22B). FIG. 22 shows the interferometer results for analyzing the morphology of wear track with 2D and 3D images. The grease with 0.5 wt % Y₂O₃ NS clearly shows a narrow and smooth surface within the wear track. In all data from the interferometer results, including a peak to valley and a roughness average, the grease with 0.5 wt % Y₂O₃ NS (FIG. 21B showed improved lubrication over the reference grease (FIG. 21A). In a roughness average data, the results show 1.094 μm in the reference grease (FIG. 21A) and 0.786 μm in grease with 0.5 wt % Y₂O₃ NS (FIG. 21B). The addition of Y₂O₃ NS allowed decreasing the irregularity of sliding surface.

### Comparison of Wear Rate

From the optical microscope and interferometer analysis, a wear depth and width were obtained to measure the wear rate. Error! Reference source not found. 1 shows the result of wear depth and width on the reference grease and the grease with 0.5 wt % Y₂O₃. The averages of wear depth and width show 2.017 μm and 263.41 μm in the reference grease and 1.967 μm and 260.36 μm in the grease with 0.5 wt % Y₂O₃, respectively. The result indicates that the wear depth and width are slightly decreased by 2.4% and 1.2%.

TABLE 1
Comparison of wear depth and width

| | Reference | | Grease with 0.5 wt. % | |
|---|---|---|---|---|
| | Grease (μm) | | Y₂O₃ (μm) | |
| No. | Wear depth | Wear width | Wear depth | Wear width |
| 1 | 2.203 | 268.84 | 2.195 | 261.16 |
| 2 | 2.132 | 273.02 | 1.831 | 268.79 |
| 3 | 2.278 | 270.71 | 2.131 | 259.25 |
| 4 | 2.068 | 248.01 | 2.023 | 278.32 |
| 5 | 1.998 | 280.63 | 1.638 | 272.62 |
| 6 | 1.788 | 257.37 | 1.857 | 268.08 |
| 7 | 1.891 | 247.88 | 1.977 | 254.68 |
| 8 | 2.207 | 249.75 | 2.184 | 242.01 |
| 9 | 1.585 | 274.53 | 1.851 | 238.35 |
| Average | 2.017 | 263.41 | 1.967 | 260.36 |

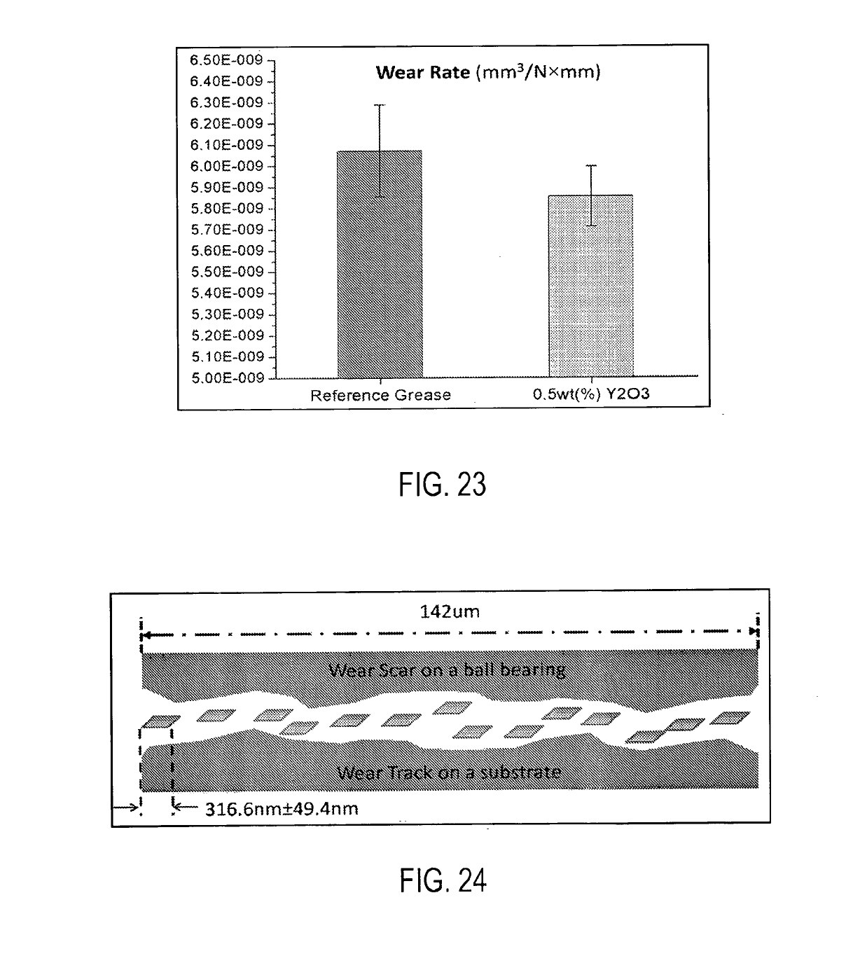

A wear rate can be calculated by a wear volume, an applied load, and a sliding distance. As a result of the calculation, the wear rate of the grease with 0.5 wt % Y₂O₃ was decreased to 3.6% than that of the reference grease, as shown in FIG. 23. This means that the addition of Y₂O₃ NSs did not show significant increase on the wear resistance of grease.

### Effects on Galling Resistance

In terms of galling resistance, the grease shows a reduced frictional behavior and an acceptable galling level with Y₂O₃ under high load. In this research, API RP 7A1 experiment was conducted for the observation on the galling resistance of grease.

The specimen was examined by the naked eye after all tests. The reference grease and the grease with 0.5 wt % Y₂O₃ did not form any galling traces or scratches between sliding surfaces. (data not shown) There were no galling traces on a substrate before and after the experiment. All visual inspections met the galling level 1 or 2. It can be explained that the grease with and without 0.5 wt % Y₂O₃ meet the requirement as lubricants.

In experiments where 0.5 wt % Y₂O₃ was added to the grease, the make-up torque is higher than the break-out torque. Therefore, the grease with 0.5 wt % Y₂O₃ performed properly as a lubricant for the galling resistance.

A friction factor is used to convert the relative frictional behavior of grease for the absolute evaluation by using a reference compound. As shown in TABLE 2, the friction factor of the reference grease is 1.261 and that of the grease with 0.5 wt % Y₂O₃ NS is 1.298. In the comparison of the friction factor, the grease with 0.5 wt % Y₂O₃ NS shows a decreased frictional behavior of 10% under high load (up to 55,000 pounds). This means that Y₂O₃ did not remain in a crystalline structure under high load. In addition, the broken nanoparticles aggregated. Subsequently, Y₂O₃ could not affect the frictional behavior of grease. Even the aggregated nanoparticles increased friction between the sliding surfaces.

TABLE 2
Slope of line on the reference grease and
the grease with 0.5 wt % Y₂O₃

| | 1^{st} | 0.5 | 2^{nd} | 1^{st} | | 2^{nd} |
|---|---|---|---|---|---|---|
| | reference | wt % | reference | reference | Super | reference |
| | compound | Y₂O₃ | compound | compound | Lube | compound |
| 1 | 3.67 | 4.84 | 4.42 | 4.19 | 4.45 | 3.97 |
| 2 | 3.64 | 4.77 | 3.63 | 3.93 | 5.42 | 3.82 |
| 3 | 3.54 | 4.79 | 3.46 | 4.06 | 4.5 | 3.69 |
| 4 | 3.35 | 4.47 | 3.51 | 4.12 | 4.58 | 3.48 |
| 5 | 3.42 | 4.56 | 3.47 | 3.87 | 4.11 | 3.49 |
| Average | 3.524 | 4.686 | 3.698 | 3.63 | 4.61 | 3.69 |

| | | |
|---|---|---|
| Friction | 1.298 | 1.261 |
| factor | | |

Mechanisms of Y₂O₃ NSs on Lubrication of Grease

The explanation on the enhanced lubrication of the grease with Y₂O₃ can be due to the shape of the nanosheets. As depicted in FIG. 24, Y₂O₃ NS could rotate and slide in the contact area. The rotating and sliding motions of nanosheets decreased the direct contact of asperities on the mating surfaces. Subsequently, the cold-welding of asperities which cause the deformation of surface was restrained, and friction was decreased with the low shear stress. In addition, the alignment of Y₂O₃NSs under an applied pressure reinforced the effect of such behavior.

The nanosheet shape of Y₂O₃ significantly improved the frictional behavior on lubrication of grease. In addition, the high thermal stability of Y₂O₃ maintained the shape of Y₂O₃ at high temperature.

### Example 7

The heavy mineral oil [Sigma-Aldrich (USA)] was used without further purification. The pseudo 2D α-ZrP nanoplatelets were synthesized using a hydrothermal method. 10 mL of ZrOCl₂ aqueous solution (12.5 mmol of ZrOCl₂.8H₂O) were added drop wise to a 30 mL solution of H₃PO₄ (12M) into a Teflon®-lined pressure vessel under constant stirring (final [H₃PO₄]=9M). Then the pressure vessel was sealed and heated at 200° C. for 24 hours. The product was washed several times with DI water and dried at 70° C. The resulting powder was grounded with a mortar and pestle into fine particles. Sample lubricants consisted of a base liquid (mineral oil or DI water) and the additives (α-ZrP nanoplatelets). The additives with different concentrations were simply dispersed in the lubricant via ultrasonication for 15 minutes before the measurements.

### Characterizations of α-ZrP Nanoplatelets

Powder X-ray diffraction (XPRD) patterns were collected with a Bruker-AXS D8 short arm diffractometer using Cu (Kα, λ=1.5418 Å) at 40 kV and 40 mA. The measurements were recorded from 4° to 40° (2é range). The measurements were recorded from 5-40° (2é range). An atomic force microscope (AFM, Nano-R2, Pacific Nanotechnology), a transmission electron microscope (TEM, JEOL 2010), and a field emission scanning electron microscope (FESEM, JEOL JSM-7500F), were used to image the 2D nanostructural features of the á-ZrP nanoplatelets and amine intercalated ZrP nanoplatelets. A FT-IR spectrometer (Thermo Scientific Nicolet 380) was used to record the infrared spectra at resolution of 4 cm⁻¹ by averaging 250 scans. The α-ZrP powder was measured using the attenuated total reflection (ATR) technique. A small amount of the liquid samples were measured after putting it between two blocks of KBr. Using a He—Ne laser source (532 nm in wavelength), the Raman spectra were recorded by a JobinYvon iHR-550 spectrometer. Thermogravimetry experiments were performed on a TGA Q500 TA Instrument to determine the percentage loading of the corresponding amine into α-ZrP in each amine intercalated ZrP nanoplatelets at the heating rate of 5° C./min from room temperature to 1000° C. under a mixture of air and N₂ (9:1). C, N, H elemental analysis was done by Robertson Microlit Laboratories.

### Lubricating and Rheological Experiments

### Nanoplatelets of the α-ZrP

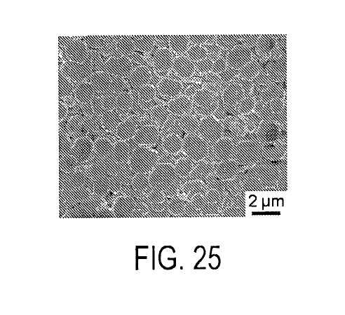

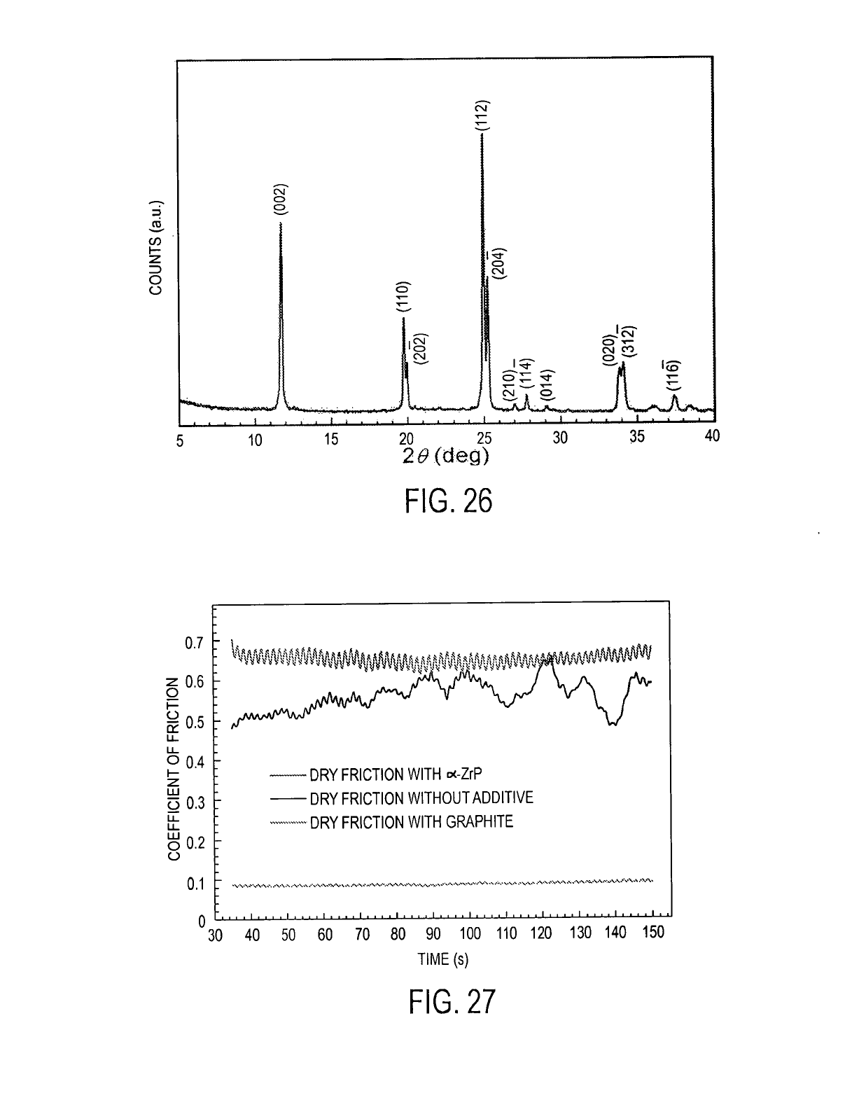

The morphology of α-ZrP nanoplatelets was characterized using FESEM, TEM, and AFM. FIG. 25 depicts a FESEM image of α-ZrP nanoplatelets. As shown in FIG. 25, the circular α-ZrP nanoplatelets have sizes that range from ˜600 nm to 1 μm. Those nanoplatelets aggregate together. α-ZrP nanoplatelets have 2D morphology and stacked layers. The representative thickness of the α-ZrP nanoplatelets is ˜30 nm. The high aspect ratio was about ˜20 to 30 for the pseudo 2D α-ZrP nanoplatelets. FIG. 26 depicts XRD patterns of the α-ZrP nanoplatelets. The XRD pattern in FIG. 26 confirms that crystal structure of the ZrP nanoplatelets is alpha phase. In α-ZrP, zirconium atoms connect to phosphate groups via oxygen atoms and form the layered structures atomically. Uniformly distributed hydroxide groups, —POH, point into the space between the two layers and maintain the spacing 7.6 Å wide through hydrogen bonding, electrostatic, and van der Waals interactions. The inter-atomic-layer interaction between two adjacent layers of ZrP is stronger than that those in the 2D nanomaterials with van der Waals bondings, e.g. graphite and its derivatives, h-BN, and transition metal dichalcogenides. To prove this, dry friction experiments were carried out and results are shown in FIG. 27. FIG. 27 depicts dry friction results with α-ZrP additives (top curve), graphite additives (bottom curve), and without any additives (middle curve). In comparison to a known solid lubricant, graphite, it is seen that that α-ZrP nanoplatelets do not show reduced friction while the graphite shows otherwise. The dry friction measurements were carried out by moving a steel ball on a stainless steel (Grade 316) plate. The α-ZrP cannot be deemed as a solid state lubricant. There is no report in using these nanoplatelets as additives in lubricants.

### α-ZrP Nanoplatelets as Lubricant Additive and Viscosity Modifier

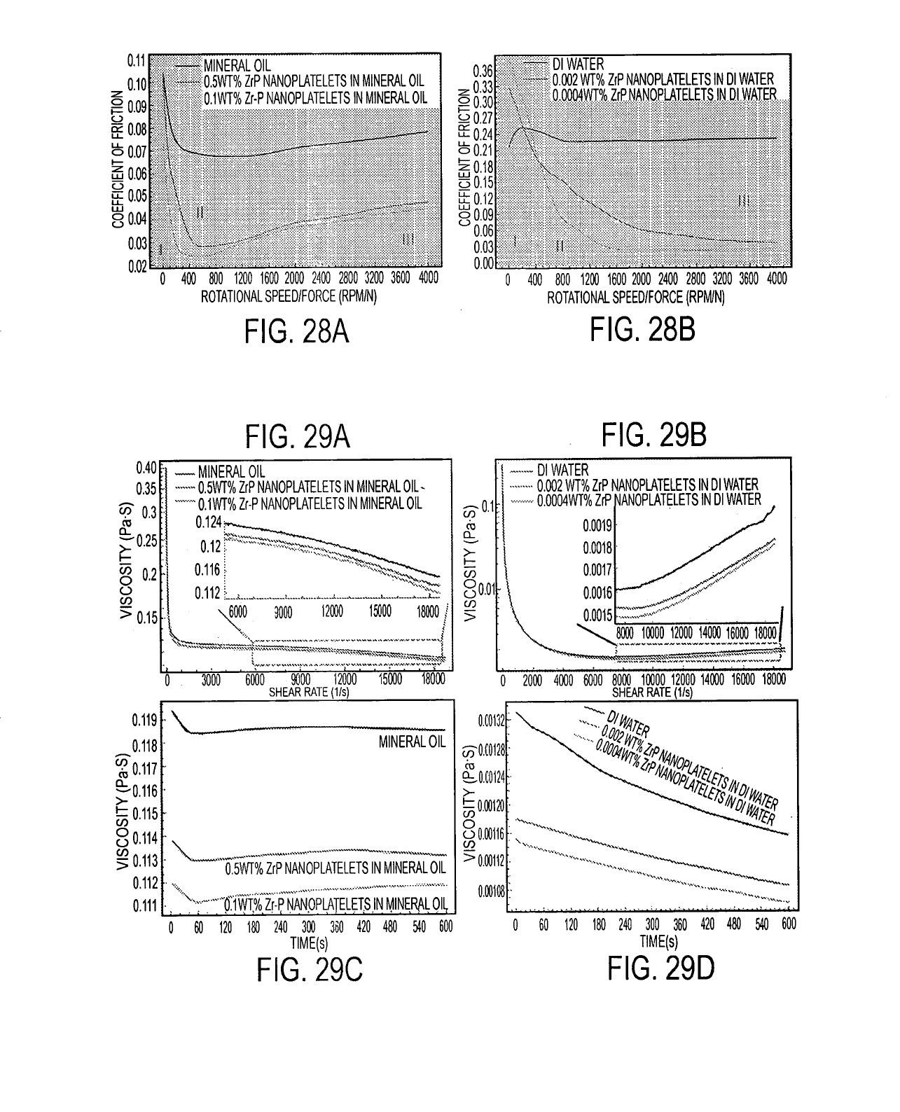

In order to examine the lubricating ability, Stribeck curves (FIG. 28A-FIG. 28B) were obtained by plotting the CoF against the Sommerfield number containing the rotational speed and the applied force. FIG. 28 depicts (A) Stribeck curves of mineral oil (top plot), and with addition of 0.5 wt % (middle plot) and 0.1 wt % (bottom plot) α-ZrP nanoplatelets additives. (B) Stribeck curves of DI water (top plot), and with addition of 0.002 wt % (middle plot) and 0.0004 wt % (bottom plot) α-ZrP nanoplatelets additives.

The CoF was recorded using a pin-on-disk tribometer (CSM Instruments). The tribological measurements were carried out via a pin-on-disk configuration consisting of a rotating disk (glass slide) and a fixed pin (steel ball). 100 μL of liquid (mineral oil or DI water with or without the additives) was added on the disk, and the radius of the wear track was set at 3 mm. The reason to set this parameter is to avoid spilling of the liquid during high speed rotation. The rotating speeds were from 10 rpm to 600 rpm under different load, 1N, 0.5 N, 0.25 N, and 0.15 N. Coefficient of friction at specific speed and load was recorded. The duration of each test was 1 minute. To plot the Stribeck curve, the averaged friction coefficients were obtained from original data and the standard deviation was used to calculate corresponding error. FIG. 28A-FIG. 28B depict the Stribeck curves of different lubricants by fitting the averaged coefficients of friction into smooth plots. The standard deviation was used to calculate corresponding error. The viscosity was measured using an AR-G2 rheometer (TA Instruments) with the shear rate ranging from 10 s⁻¹ to 18740 s⁻¹. During experiments, a stainless steel parallel spindle (Ø 25 mm) rotated while the lower Peltier plate was stationary. A test liquid filled the gap of 200 μm between parallel plates. The temperature was maintained at 25° C. The fluid shear was examined under a constant shear rate of 10000 s⁻¹ for 10 minutes. The change in viscosity was tracked in time.

The effects of α-ZrP nanoplatelets as additives in mineral oil are shown in FIG. 28A. With the addition of 0.5 wt % and 0.1 wt % α-ZrP nanoplatelets, the friction coefficient is reduced significantly in ranges from boundary lubrication (BL) regime I, to mixed lubrication (ML) regime II, and through hydrodynamic lubrication (HL) regime III. The mineral oil containing 0.1 wt % of α-ZrP nanoplatelets shows slightly lower friction coefficient than that contains 0.5 wt % of α-ZrP nanoplatelets. In addition, friction in water is reduced in the presence of α-ZrP nanoplatelets additives (FIG. 28B). A lower concentration of α-ZrP nanoplatelets leads to further decrease in CoF. Results show that addition of α-ZrP nanoplatelets in mineral oil (0.1 wt %) and in water (0.0004% wt) reduced friction maximally by 65% and 91%, respectively.

To understand mechanisms of friction reduction, effects of α-ZrP nanoplatelets on viscosity were studied. The viscosity of a fluid reflects its load-carrying capability. The viscosity is a measure of the relative movement-resistance between flow-layers. The resistance influences the friction in ML and HL regimes. These results are shown in FIG. 29A and FIG. 29B. FIG. 29A-FIG. 29D depict (FIG. 29A) Variation of viscosity with shear rate in mineral oil (top plot), and with addition of 0.5 wt % (middle plot) and 0.1 wt % (bottom plot) α-ZrP nanoplatelets additives. (FIG. 29B) Variation of viscosity with shear rate in DI water (top plot), and with addition of 0.002 wt % (middle plot) and 0.0004 wt % (bottom plot) α-ZrP nanoplatelets additives. (FIG. 29C) At a constant shear rate (10000 s⁻¹), reduction in viscosity of mineral oil (top plot) in the presence of α-ZrP nanoplatelets with concentrations of 0.5 wt % (middle plot) and 0.1 wt % (bottom plot). (FIG. 29D) At a constant shear rate (10000 s⁻¹), reduction in viscosity of DI water (top plot) in the presence of α-ZrP nanoplatelets with concentrations of 0.002 wt % (middle plot) and 0.0004 wt % (bottom plot). Without α-ZrP nanoplatelets, shear-thinning was observed for the mineral oil, whereas a transition from shear thinning to shear thickening was found in water. The addition of α-ZrP nanoplatelets does not change the non-Newtonian characteristics of the base liquids. The additives are capable of reducing their viscosity (mineral oil or DI water). The most reduction in viscosity was achieved at the lowest concentration of α-ZrP nanoplatelets, i.e, by ˜3% in mineral oil and by ˜12% in water. To further understand the shear thinning phenomenon, a thixotropic study was conducted, and the results are shown in FIG. 29C and FIG. 29D. Under a constant shear rate, a rapid drop of viscosity at the initial stage of the shearing (<60 s) is observed for mineral oil (FIG. 29C). The entanglement of long organic molecules in mineral oil is destroyed at the beginning of shearing. On the contrary, the physical interaction between long-chain alkane molecules enables a continuous rebuilding of the damaged entanglement. The competing process of destruction and rebuilding eventually reaches a kinetic balance, resulting in a relatively stable viscosity. This happens after more than >60 s of shear, as shown in FIG. 29C. In the case of water, its viscosity keeps decreasing under a constant shear rate (FIG. 29D). This indicates the aqueous fluid structure undergoes an irreversible shearing process. As seen in results, in either mineral oil or water, under a constant shear rate, the α-ZrP nanoplatelets additives reduce their viscosity as much as 7% (FIG. 29C) for oil and 14% (FIG. 29D) in water.

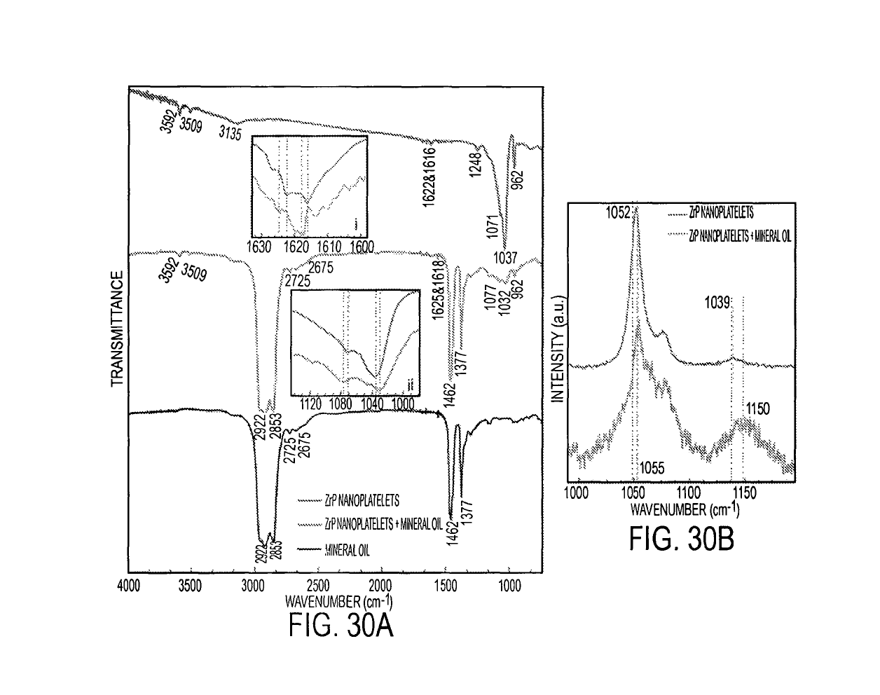

Interaction between the organic molecules in mineral oil and additives was investigated. FIG. 30A-FIG. 30B shows the infrared and Raman spectra. The mineral oil is a mixture of alkanes in the C15 to C40 range. FIG. 30A-FIG. 30B depict (FIG. 30A) comparison of infrared spectra of α-ZrP nanoplatelets (top curve), mineral oil (bottom curve), and mineral oil containing 0.5 wt % α-ZrP nanoplatelets (middle curve). (FIG. 30B) Comparison of Raman spectra between α-ZrP nanoplatelets (top curve) and mineral oil containing 0.5 wt % α-ZrP nanoplatelets (bottom curve). Its infrared spectrum (bottom plot in FIG. 30A) shows a series of characteristic vibrations on the long-chain alkane molecules: C—H (CH₃—CH₂—) asymmetric and symmetric stretching vibrations (2853 and 2922 cm⁻¹), C—H (—CH₂— and —CH₃) bending deformation (1377 and 1462 cm⁻¹), and C—H aldehyde stretching vibration (2675 and 2725 cm⁻¹). Other characteristic vibration modes are observed from the infrared spectrum of α-ZrP nanoplatelets (top red plot in FIG. 30A): —O—H stretching vibrations in water molecules (˜3509 and 3592 cm⁻¹), P—O—H stretching vibration (3135 cm⁻¹), intermediate vibrations of water molecules (1616 and 1622 cm⁻¹), P—O—H deformation vibration (1248 cm⁻¹), vibrations of the orthophosphate group (1037 and 1071 cm⁻¹), and formation of pyrophosphate groups (962 cm⁻¹). Shift of some of those vibration modes are observed after mixing α-ZrP nanoplatelets with mineral oil. Inset i of FIG. 30A shows shifts of intermediate vibrations of water molecules (1616→1618 cm⁻¹ and 1622→1625 cm⁻¹, respectively). Vibration mode shifts in the orthophosphate group (1037→1032 cm⁻¹ and 1071→1077 cm⁻¹) are shown in inset ii of FIG. 30A with peak broadening. The nanoplatelet has a significantly large surface area, ˜1000 nm². The surface provided active sites to interact with the alkane groups from mineral oil. The shifts represent modification of vibration-induced stress/strain states on the surface of α-ZrP nanoplatelets. The enlarged width indicates that the orthophosphate groups are involved in interactions with organic molecular groups from the mineral oil. In FIG. 30B, characteristic vibration-based inelastic scattering from orthophosphate group of α-ZrP nanoplatelets displays shifts on Raman spectra. It is evident that long-chain organic molecules in mineral oil interact with the surface of α-ZrP nanoplatelets. The interaction resulted in friction and fluid drag reduction.

### Mechanisms of Lubrication

Schematics show interaction between lubricant molecules and α-ZrP surface, formation of dipole-dipole complex, and ordered alignment of α-ZrP nanoplatelets in the lubricants. There are three possible reasons of lubricating enhancement in ML regime. Reasons for this are 1). interaction between lubricant molecules and α-ZrP surface; and 2) viscosity modification induced by α-ZrP nanoplatelets. The first reason is the intermolecular interaction. The α-ZrP has a layered structure. Three oxygen atoms from one phosphate group bond with three different zirconium atoms, forming a cross-linked covalent network inside the plane. The fourth oxygen atom of the phosphate is perpendicular to the layer pointing toward the interlayer area. Between two atomic layers of α-ZrP, a basal water molecule resides in a zeolitic cavity, forming a hydrogen bonding with the OH group of the phosphate. After adding the α-ZrP nanoplatelets in mineral oil, the alkane molecules, interact with the surface of α-ZrP via van der Waals dispersion forces. In the α-ZrP nanoplatelets, the hydrogen bonding is mainly between phosphate groups and/or water molecules. Mineral oil brings more organic groups, including but not limited to methyl, methylene, aldehyde, in contact with the surface of α-ZrP nanoplatelets. The shifts in the infrared and Raman spectra suggest the formation of a dipole-dipole complex among these functional groups.

The second reason is the α-ZrP nanoplatelets-induced viscosity modification. Such behavior has been reported that is consistent with the inventor's results in viscosity reduction (FIG. 29). The pseudo 2D nanostructure can facilitate alignment of α-ZrP nanoplatelets in an orderly manner by applying a perpendicular fluid pressure. The alignment of the nanoplatelets would decrease the momentum transfer between fluid layers. As a result, the laminar separation-induced reduction in fluid drag was believed to be responsible for the viscosity reduction. In the HL regimes (regimes III in FIG. 28A-FIG. 28B), The characteristic of hydrodynamic lubrication is that a complete lubricant film forms as the contact surfaces are separated. The separation is a result of hydrodynamic lift. A converging gap is the necessary geometry to produce hydrodynamic lubrication. The hydrodynamic pressure and the load are in the kinetic equilibrium state in HL regime. The low viscosity of the lubricants with the presence of aligned α-ZrP nanoplatelets was evident in FIG. 29. The low viscosity is directly responsible for the reduction in hydrodynamic friction.

In the ML regime, protuberant areas are in contact due to surface asperity. A lubricant is resisted due to the contact, inducing the friction. When α-ZrP nanoplatelets (tens of nm thin) are added, they are promoted to enter the contacted area driven by the lubricant flow. Simultaneously, the large surface area of α-ZrP nanoplatelets supplies more lubricant molecules in the contact area. Aligned α-ZrP nanoplatelets along the fluid direction eliminate the fluid drag and further reduce the viscosity. More efficient lubrication is obtained in ML regimes (regimes II) in FIG. 28A and FIG. 28B.

The boundary lubrication (BL, regime I in FIG. 28A and FIG. 28B) is observed under conditions of high pressure and viscosity and low speed. BL characteristics are high friction, large surface contact, and little fluid is trapped between two surfaces. As the load is decreased, or the viscosity and speed are increased, a fluid film forms while the surfaces are separated. The film begins to support the load, even though it remains thin. A dramatic drop of friction is often observed on the Stribeck curve when mixed lubrication (ML, regime II in FIG. 28A and FIG. 28B) appears. A thick film forms as the surfaces are separated with the increased viscosity and speed. A transition from ML to HL (regime III in FIG. 28A and FIG. 28B) is obtained when the minimum friction is observed on the Stribeck curve. In the HL regime, a higher load can be applied to a thicker film. Due to the fluid drag, the friction increases again.

### Example 8

### Preparation of α-ZrP Nanoplatelets

Zirconyl chloride octahydrate (>99.0%) was purchased from Fluka. Butylamine (99.5%), propylamine (98%) and ethylenediamine (99%) were purchased from Sigma Aldrich. All chemicals were used without further purification. The α-ZrP nanoplatelets were synthesized by the hydrothermal method reported by Sun and coworkers. In summary, 4.0 g of ZrOCl₂.8H₂O was mixed well with 40.0 mL 12 M H₃PO₄ in a sealed Teflon®-lined pressure vessel and heated at 200° C. for 24 h. The product was washed with distilled water and isolated by centrifuging three times at 5000 rpm, and dried at 70° C. for 24 h.

Intercalation of Amine into α-ZrP Nanoplatelets

The intercalation of butylamine, propylamine and ethylenediamine into α-ZrP nanoplatelets were reported elsewhere and prepared with slight modifications. 1 g of α-ZrP nanoplatelets was suspended in 150 mL of distilled water. A stoichiometric amount of amine was added to the ZrP suspension, and allowed to stir for five days. The molar ratio of ZrP:amine were 2:1, 2:1, and 1:1 for butylamine, propylamine and ethylenediamine, respectively. The products were rinsed with distilled water, isolated by centrifuging three times at 5000 rpm, and dried at 70° C. for 24 h.

### Characterization of α-ZrP and Amine Intercalated ZrP Nanoplatelets

### Tribological Experiments

The nanoplates were mixed with a heavy mineral oil (supplied by Sigma Aldrich) to generate the lubricants for measurements of viscosity and CoF. Three concentrations of α-ZrP in mineral oil (0.1 wt %, 0.2 wt % and 0.5 wt %) were used. In order to achieve a homogeneous distribution of α-ZrP, the mixtures were ultrasonically treated for 20 min. The viscosities of these lubricants were evaluated using a rheometer (AR-G2, TA instruments, USA). The shear rate ranged from 10 s⁻¹ to 10000 s⁻¹. The CoF was measured using a pin-on-disc tribometer (CSM Instruments, Switzerland). In tribotests, the prepared lubricants were introduced into the gap between a fixed pin (E52 100 steel ball with a diameter of 6.35 mm) and a rotating disc (a piece of glass slide attached to a rotating stage). The rotational diameter of the pin on the disc was 6 mm Applied loads varied from 0.15 N to 4 N while rotating speeds changed from 10 rpm to 600 rpm. Each test was repeated for three times and the average value was used as the effective CoF. All tribological and rheological measurements were conducted at room temperature.

### Characteristics of Nanoplatelets

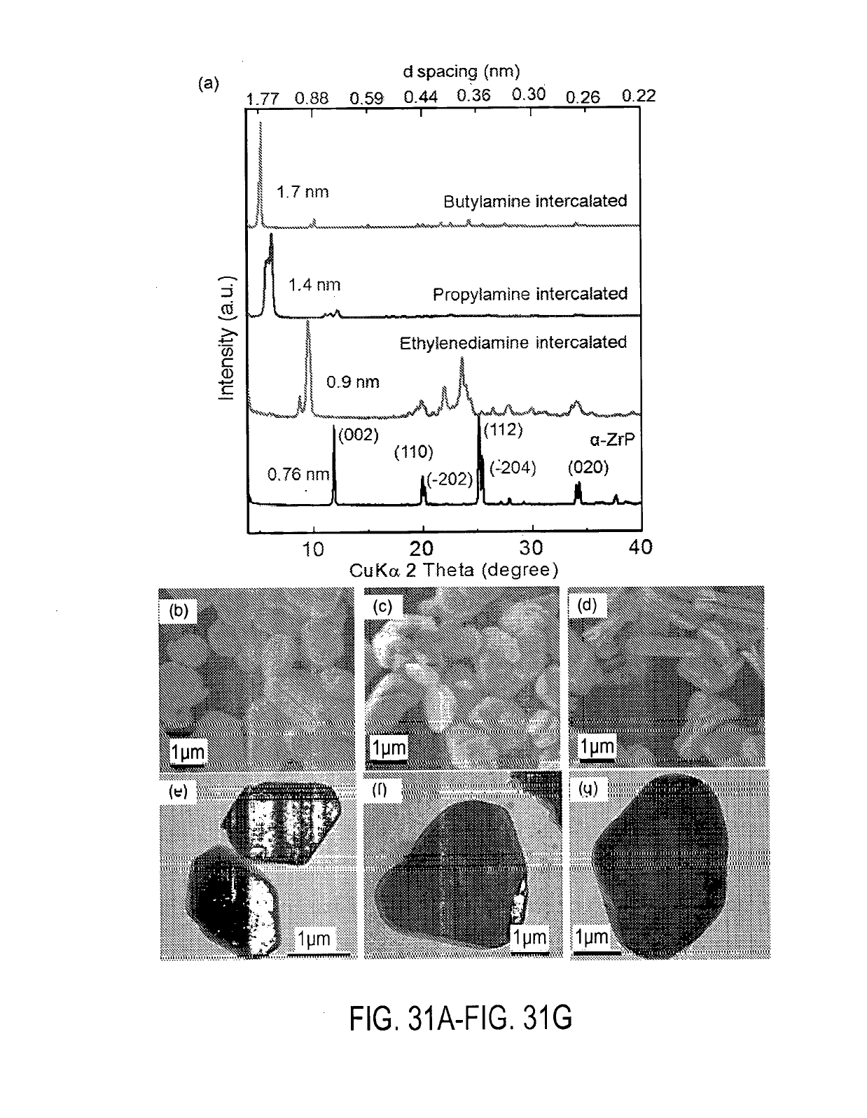

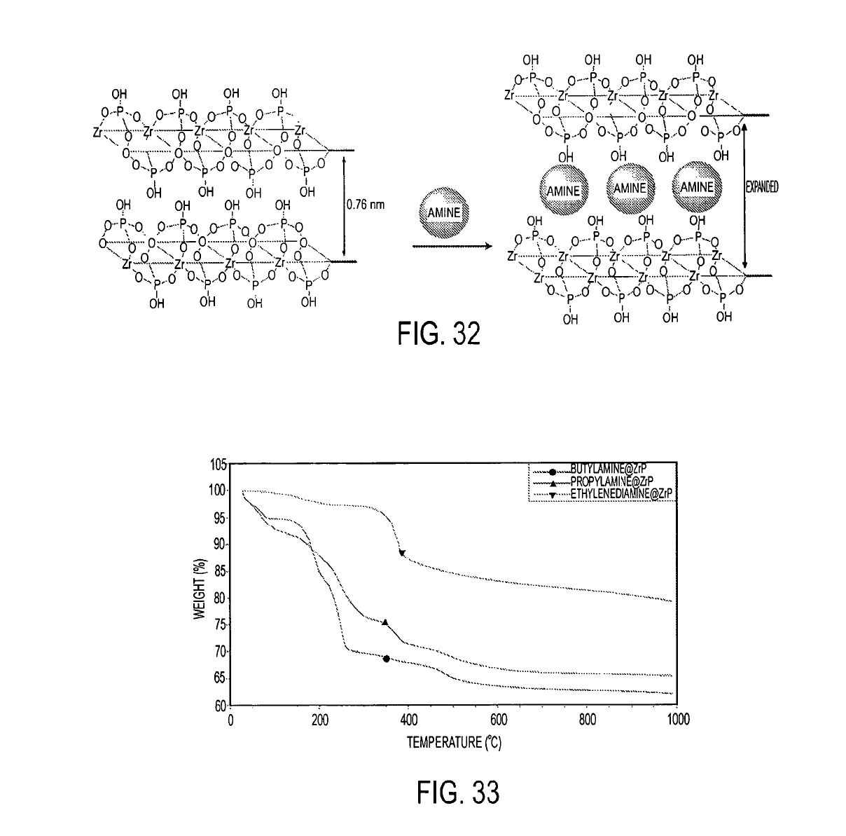

Initially the materials were characterized by XRD to verify the intercalation of amine into α-ZrP nanoplatelet. XRD patterns (FIG. 31A), SEM (FIG. 31B, FIG. 31C, FIG. 31D) and TEM (FIG. 31E, FIG. 31F, FIG. 31G) images of α-ZrP with and without intercalation are depicted. Ethylenediamine intercalated (FIG. 32B, FIG. 31E), propylamine intercalated (FIG. 31C, FIG. 31F), and butylamine intercalated (FIG. 31D, FIG. 31G). FIG. 31A shows the XRD patterns for the pristine α-ZrP and the amine-intercalated materials. The interlayer spacing of pristine α-ZrP is 7.6 Å, which is determined by the (002) reflection peak in XRD pattern. All amine intercalated α-ZrP materials resulted in a mixture of phases whose interlayer spacings are slightly different. The intercalation of butylamine into α-ZrP yielded a mixture of 17.4 Å phase and 16.9 Å phase. The intercalation of propylamine into α-ZrP yielded three phases with interlayer spacings of 15.5 Å, 15.1 Å and 14.4 Å. Two phases were obtained for the intercalation of ethylenediamine into α-ZrP at the interlayer spacing of 10.1 Å and 9.3 Å. It has been previously been reported that the coexistence of several phases with different interlayer spacing indicated the different orientation of amines within the layers. FIG. 32 depicts an idealized representation of amine intercalation process. The increase of interspace between ZrP layers after intercalation is represented in FIG. 32.

Thermogravimetric experiments (TGA) were performed to determine the loading of amine within the materials. In butylamine and propylamine intercalated ZrP materials, three main weight losses were observed: The first below 200° C. is attributed to surface water and interlayer water, the second from about 220 ˜400° C. is due to amine loss, and then followed by the condensation to zirconium pyrophosphate at ˜470° C. In ethylenediamine intercalated ZrP material, surface and interlayer water are lost below 200° C., and the amine loss occurs with the condensation of monohydrogen phosphate to pyrophosphate together start from 250° C. and continues to high temperature. Also, CHN elemental analysis was performed to confirm the formula of this sample. Elemental analysis results show that the sample contains 5.78% carbon, 2.64% hydrogen and 6.63% nitrogen. Combining TGA and elemental analysis results, the formula of the three amine intercalated ZrP can be obtained. The formula of the materials are Zr(C₄H₉NH₂)1.67(HPO₄)₂.0.59H₂O, Zr(C₃H₇NH₂) 1.52(HPO₄)₂.1.21H₂O and Zr(NH₂C₂H₄NH₂) 0.82(HPO₄)₂.0.54H₂O, respectively. FIG. 33 depicts TGA of butylamine intercalated ZrP (●curve), propylamine intercalated ZrP (▴curve) and ethylenediamine intercalated ZrP (▾curve).

Several phases form as a function of the loading. In the case of propylamine a phase containing 4.5 meq/g exhibits an interlayer spacing of 14.6 Å. At the highest loading the interlayer spacing was 17.4 Å. For butylamine a phase with a d-spacing of 17.7 Å was obtained at a loading of about 4.5-5.0 meq/g. The maximum loading, close to a formula of Zr(C₄H₉NH₂)₂ (HPO₄)₂.H₂O had an interlayer spacing of 18.6 Å. These values are close to those found in the present study. The observed X-ray patterns depend not only on the amount of amine taken up but also the water content of the solid. At or near the uptake of half the loading of propylamine, i.e. 3.32 meq/g or 1 mol per mol of ZrP, the particles spontaneously exfoliate. Further uptake of amine results in recrystallization of the particles. TEM images and SEM images show that the nanosheets have a hexagon like shape. The short edge is 0.8 μm and the long edge is 2 μm. The intercalation has no significant impact on the size and shape of a single nanosheet. In the TEM images, the multilayer structure can be determined at the edges.

### Tribological Performance

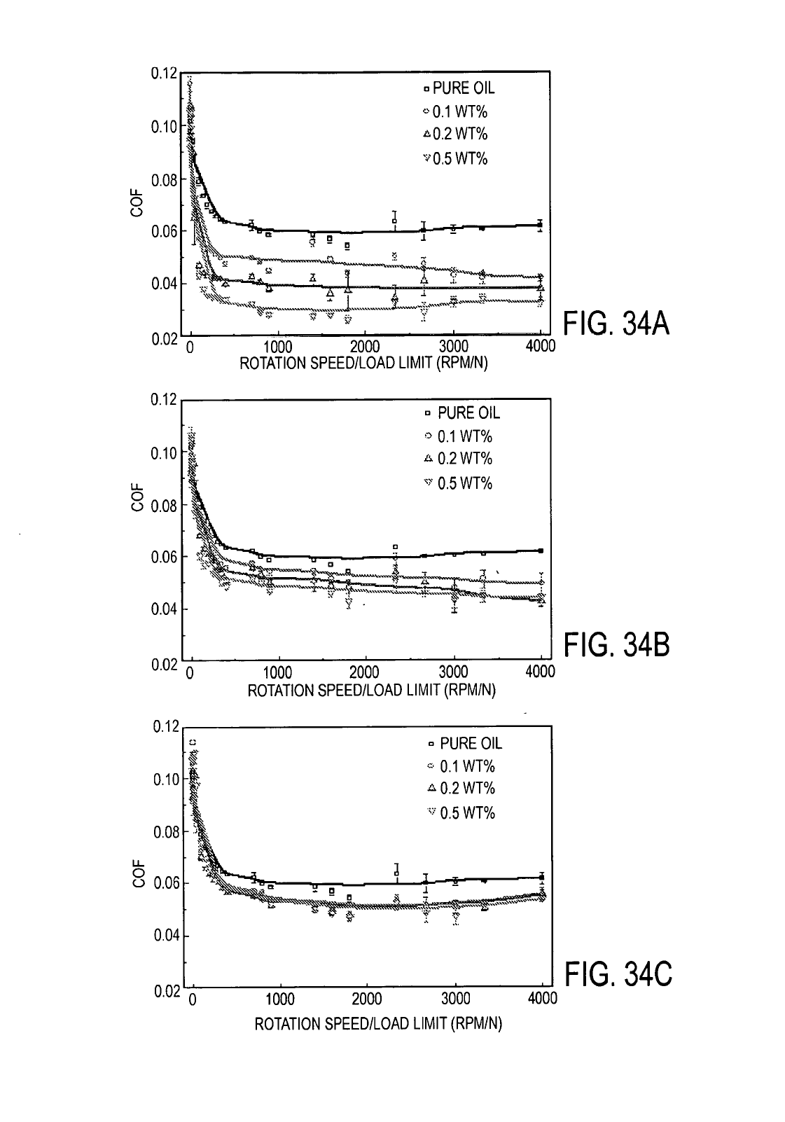

To evaluate the effectiveness of nanoplatelets on frictional behavior, the intercalated α-ZrP were added into a mineral oil and tribotests were conducted. The overall lubricating performance was evaluated by measuring the CoF between the steel pin and the glass disc. FIG. 34A-FIG. 34C depict friction coefficient as a function of rpm/N obtained in a heavy mineral oil with intercalated α-ZrP additives. (FIG. 34A) Ethylenediamine intercalated. (FIG. 34B) Propylamine intercalated. (FIG. 34C) Butylamine intercalated. Symbols present obtained measurements and solid lines are smoothed results. In FIG. 34A-FIG. 34C, the y-axis is the CoF while the x-axis is the ratio of the rotating speed over applied load. As widely accepted that a Stribeck curve is based on the Sommerfield grouping number, speed·viscosity/load. At the high shear rate region, the change of viscosity is relatively small. To simplify the discussion with tolerable error, speed/load ratio was used as a substitute of Sommerfield number. As shown in FIG. 34A-FIG. 34C, in all the cases, there is a rapid drop of CoF at low speed and high load regime (low ratio). This is because of the transition from boundary lubrication to mixed lubrication. Then the CoF becomes stable and lubrication state turns to hydrodynamic lubrication. With the intercalated α-ZrP additives, the friction between the pin and the disc is effectively reduced. In FIG. 34A, the CoF is progressively reduced when more ethylenediamine intercalated α-ZrP is added in the mineral oil. At 0.5 wt %, the CoF is about half of the value measured in pure oil. For the lubricant with propylamine intercalated α-ZrP, similar observation can be seen in FIG. 34B. The CoF decreases as the concentration of additives increases. In the high speed or low load region, the CoF reduces to ˜0.048 compared to ˜0.06 for pure oil. When butylamine intercalated α-ZrP is used, the concentration of additive shows no observed effect on CoF as presented in FIG. 34C. All the three types of intercalated α-ZrP share similar performance in reducing friction.

There is a variation of viscosities of the prepared lubricants with increasing shear rate. Viscosities reduce with increasing shear rate, a sign of shear thinning of the lubricants. A notable decrease of viscosity can be seen after α-ZrP additives are added into mineral oil. When ethylenediamine intercalated α-ZrP is used, the viscosity of the lubricant gradually decreases with an increase in concentration. At the concentration of 0.5 wt %, the viscosity is 0.128 Pa·s, which is 5.9% lower than that of pure oil (0.136 Pa·s). A decrease in viscosity can be seen using lubricant with propylamine intercalated α-ZrP. The lowest viscosity is observed at the concentration of 0.2 wt %, with a maximum reduction in viscosity of about 8.5%. For all the three types of intercalated α-ZrP, the one with butylamine shows the best performance in decreasing viscosity of mineral oil. The measured viscosity at 0.2 wt % is 0.124 Pa·s, is an 8.8% decrease compared to pure oil. The impact of additive concentration almost disappears in the case of butylamine intercalated α-ZrP because only a subtle difference can be seen between the lines.

According to Einstein theory, the viscosity of a suspending liquid is positively related to the concentration of particles in the suspension. Recent studies reported that organic and inorganic particles reduced viscosity of the base polymer liquid due to the increase of free volume. In this study, the mineral oil is composed of various alkanes with molecular chain ranging from C15 to C40. With a bond length of 0.154 nm and a bond angle of 109.5° of the C—C bond, the estimated total length of the alkane molecular chain ranged from 1.75 nm to 4.88 nm assuming that the alkanes have a linear chain structure. The interlayer spacing of the intercalated α-ZrP additives is 0.9 nm to 1.7 nm as shown in FIG. 31. As a result, there is a small chance for the alkane molecules to enter the gap between two adjacent layers. The reduction of friction with the addition of α-ZrP nanosheets is illustrated in FIG. 34. A drag force could be sufficient to shear the 2D particles with spacing. At low speed/load region, the nanosheets transported into the contact area effectively separate the asperities as shown in FIG. 35A, leading to less direct contact between the hard surfaces and lower friction. At high speed/load region, it is accepted that the liquid flow is laminar Alignment of nanosheets in the liquid with small angles of inclination is one possible explanation for the reduced viscosity and friction compared to pure mineral oil. FIG. 35A-FIG. 35C depicts (FIG. 35A) schematic of contact area with α-ZrP additives at low speed/load region; (FIG. 35B) contact area at high speed/load region with laminar flow; and (FIG. 35C) relationship between drag coefficient and interlayer space. The following formula can be used to calculate the drag coefficient, CD, for plates in a laminar flow:

$${C}_{D} = 3.43 \frac{1}{\sqrt{Re}} \frac{1}{{Φ}^{\frac{3}{4}}} \qquad ( 1 )$$

In Eq. (1), Φ is sphericity of a nonspherical particle and defined as the ratio between the surface area of a sphere and the surface area of the studied particle with the same volume. Re is the Reynolds number of a particle in a liquid. Obviously, the sphericity increases with the interspace of the nanosheets. On the basis of Eq. (1), the drag coefficient is negatively related to Reynolds number and sphericity. At a constant fluidic speed, these 2D nanosheets share similar Reynolds number. As a result, the sequence of the drag coefficient for the α-ZrP from high to low is ethylenediamine intercalated, propylamine intercalated, and butylamine intercalated. Higher drag coefficient means more resistance force when the particles flow in the mineral oil so the viscosity of the mixed lubricant is higher as well. This is a possible explanation for the measured viscosity.

### Example 9

The testing of a lubricant and an additive can utilize a tribometer experiment, galling experiment, and wear evaluation. In an embodiment, the lubricant is a grease with Teflon® and the additive is α-zirconium phosphate. In an embodiment, the substrate used for the testing is Inconel® alloy 718. In an embodiment the pin is an E52100 steel ball (Ø 6.35 nanometers). The grease with Teflon® and α-ZrP can be mixed by mortar and pestle.

The tribometer experiments can be performed on a pin-on-disc tribometer or a high temperature tribometer. The pin-on-disc tribometer can have a rotating speed of 50-400 rotations per minute (RPM), an applied load of 1-10 N, and can be run at room temperature. The high temperature tribometer can have a rotation speed of 100 RPM, an applied load of 22 N, and can be run at a temperature of 25° C.−200° C.

In an embodiment, the galling experiment can be performed with an applied load of 55,000 pounds and with a rotating speed of 2 RPM. The substrate can be visually inspected for galling trace. Data analysis can include calculation of make-up and break-out versus turns and friction factor.

The wear evaluation can be performed by characterization of the worn surface using an optical microscope and an interferometer.

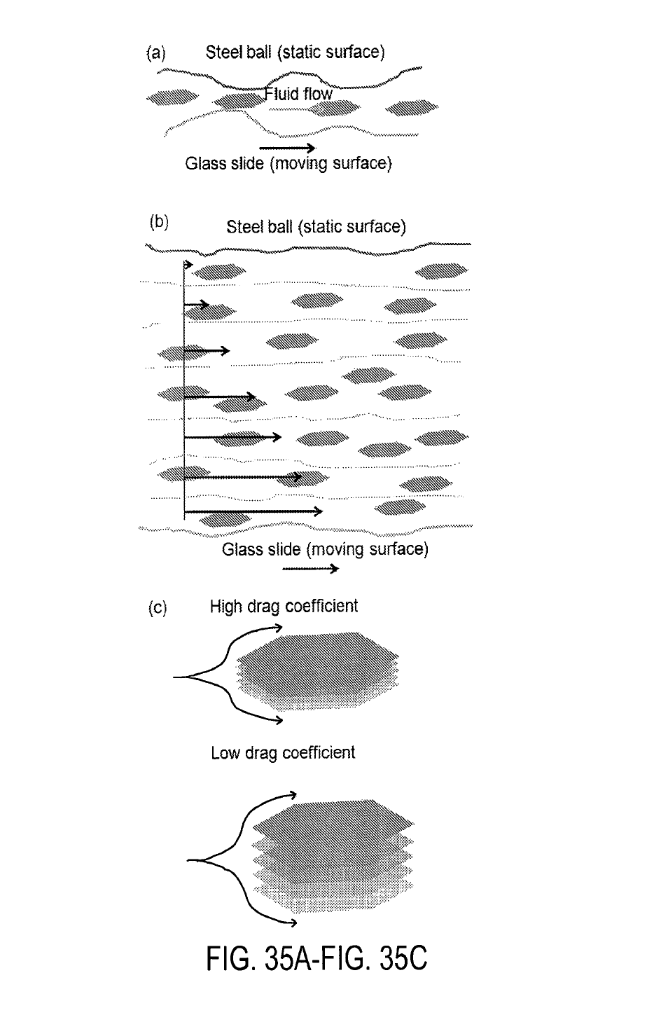

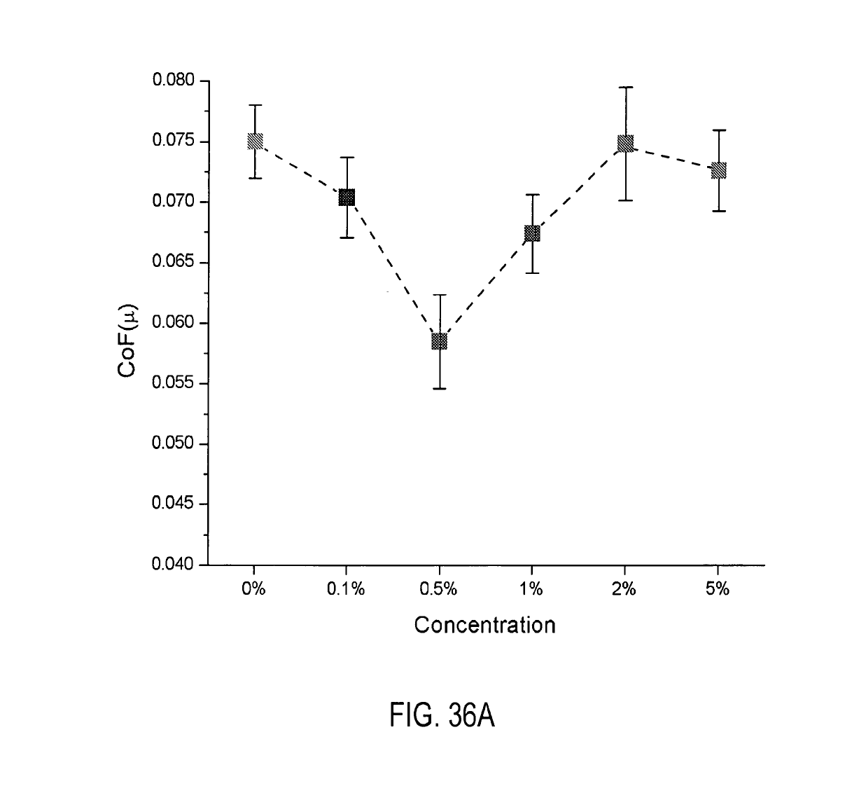

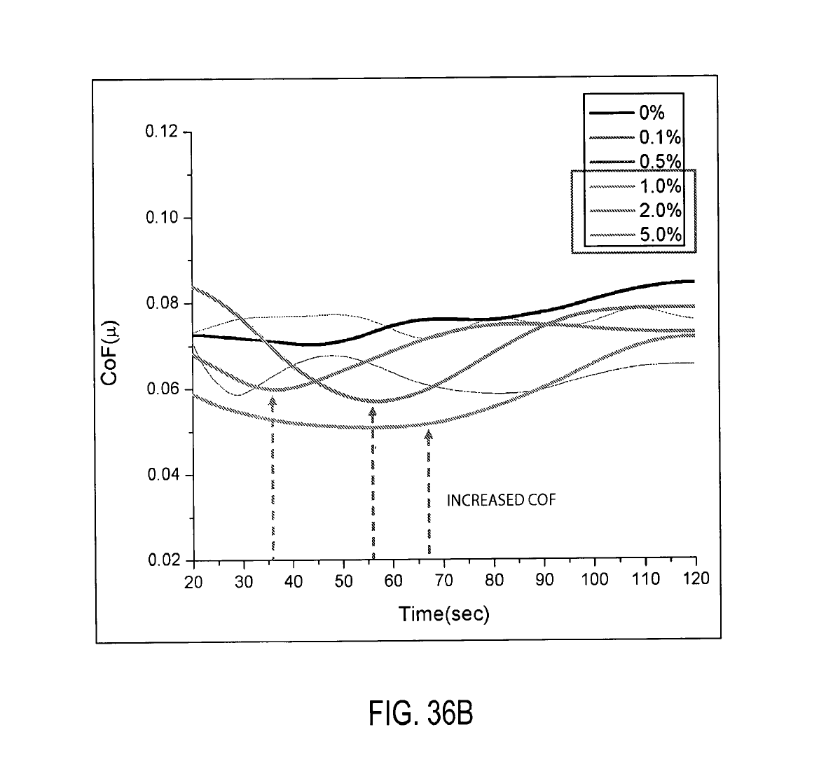

α-ZrP reduces friction at room temperature at a load of 3N, a speed of 150 RPM, for a time of 2 minutes, and sliding distance of 6 m. N is the abbreviation for the load. Varying concentrations of α-ZrP were tested. FIG. 36A and FIG. 36B. The CoF is the ratio of the force of friction between two bodies and the force pressing them together. The CoF is represented by μ. The lowest coefficient of friction is at 0.5% α-ZrP. The CoF decreased by 22%. FIG. 36A.

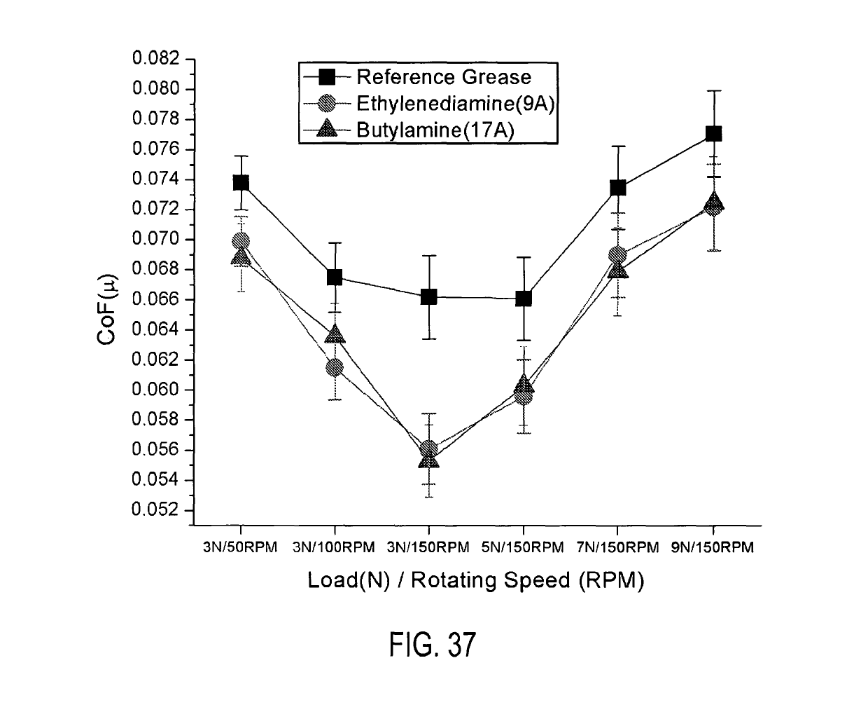

Aminated α-ZrP also reduces friction at room temperature. The CoF was determined at varying loads (between 3-9N) and varying speed (50-150 RPM) for 2 minutes. FIG. 37. The CoF decreased by 15.3% with ethylenediamine (with a space between layers of 9 angstroms), compared to the reference grease. The lowest CoF was for butylamine (with a space between layers of 17 angstroms). The CoF decreased 16.5% at a load of 3N and a rotating speed of 150 RPM.

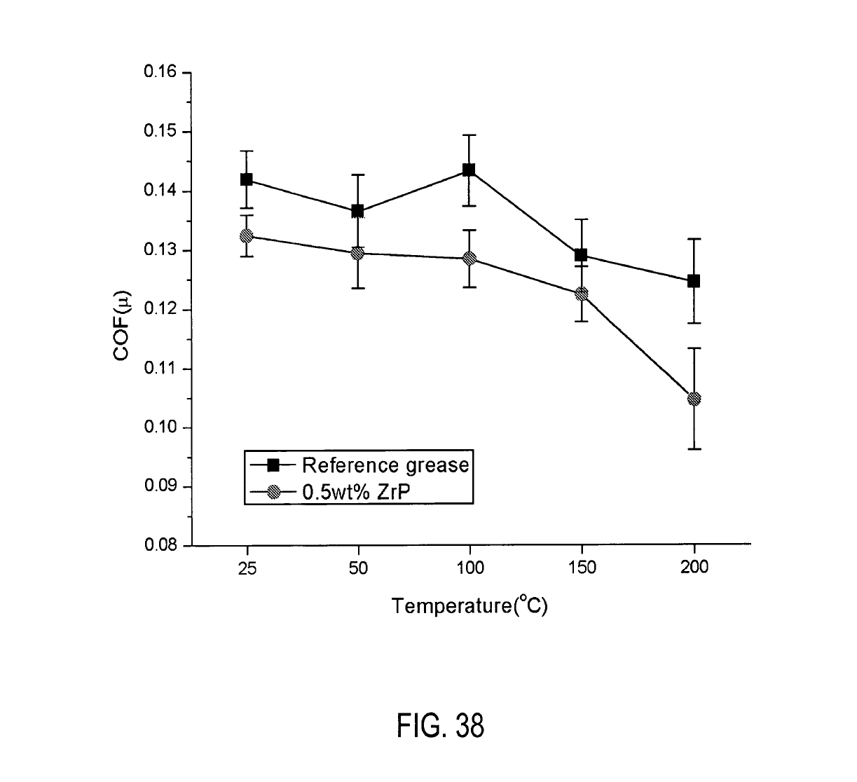

α-ZrP also reduces friction at high temperature. There was an average decrease in the CoF of 8.6% compared to the reference grease at temperatures varying from 25-200° C., 0.5% by weight of α-ZrP at a load of 22.2N, speed of 100 RPM, and a time of 10 minutes. FIG. 38. The viscosity decreased with increasing temperature in the presence of 0.5% by weight of α-ZrP.

α-ZrP enhances galling resistance with reduced friction. The friction factor is calculated as follows:

F·F=2×S₂/S+S₃

Wherein S₁ is the first 5 runs of the reference compound, S₂ is 5 runs of the test thread compound, and S₃ is the second 5 runs of the reference compound.

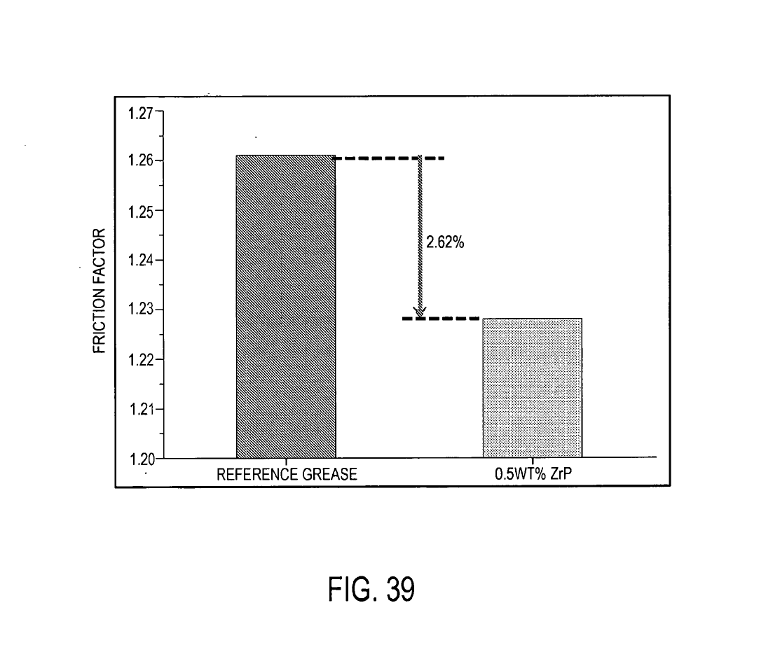

Friction and adhesion are reduced in the contact area. TABLE 3. The friction factor decreased 2.62% between the reference grease and 0.5 wt % α-ZrP. FIG. 39.

TABLE 3

| Slope | 1^{st} | Refer- | 2^{nd} | 1^{st} | 0.5 | 2^{nd} |
|---|---|---|---|---|---|---|
| of | reference | ence | reference | reference | wt % | reference |
| Line | compound | grease | compound | compound | α-ZrP | compound |
| 1 | 4.19 | 4.45 | 3.97 | 3.67 | 4.47 | 3.7 |
| 2 | 3.93 | 5.42 | 3.82 | 3.7 | 4.67 | 3.67 |
| 3 | 4.06 | 4.5 | 3.69 | 3.54 | 4.43 | 3.45 |
| 4 | 4.12 | 4.58 | 3.48 | 3.35 | 4.2 | 3.56 |
| 5 | 3.87 | 4.11 | 3.49 | 3.55 | 4.22 | 3.56 |

| | | |
|---|---|---|
| F/F | 1.261 | 1.228 |

The nanoplatelet shape reduces friction. The shape slides and rotates, prevents cold-welding, reduces shearing force, and reduces friction and adhesion between the ball and substrate.

Concentration is important for the effects of α-ZrP. At concentrations above 0.5 wt % α-ZrP, stacks of nanoparticles can form and the CoF increases.

α-ZrP protects surfaces from deformation and wear. This was depicted in the optical microscope images and 2D surface morphology of the wear track with the reference grease and with the addition of α-ZrP.

Enhanced wear resistance is obtained in the presence of α-ZrP. Reduced friction provides a reduced wear rate. Wear rate is calculated as follows:

Wear rate=depth×width×length/applied force×sliding distance

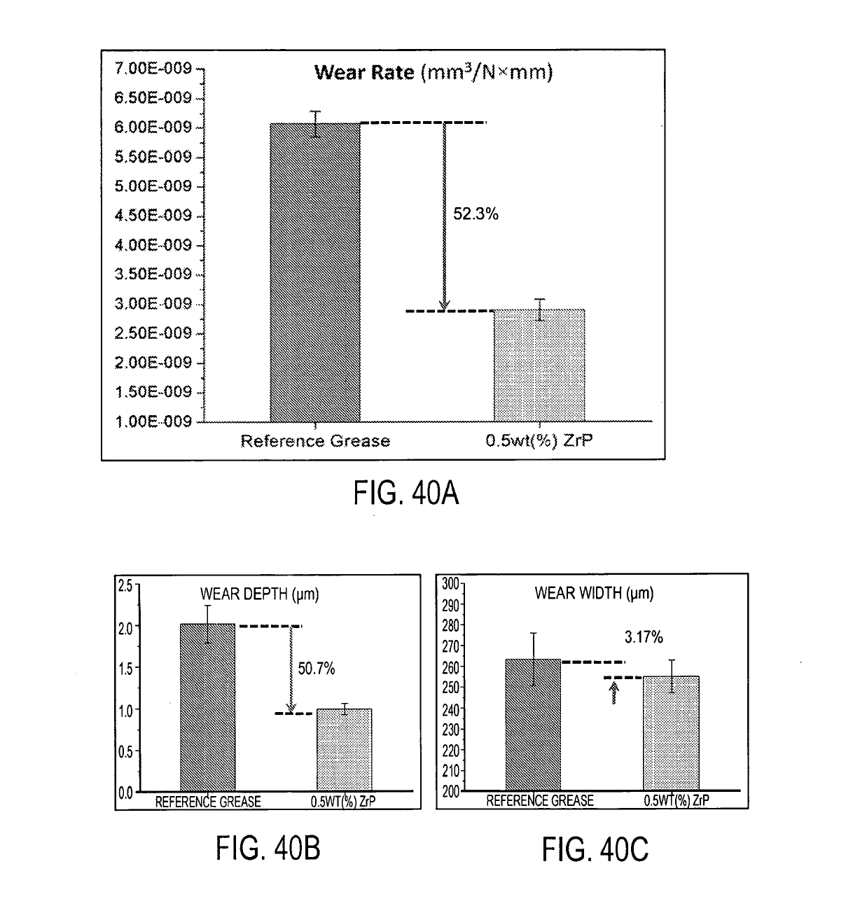

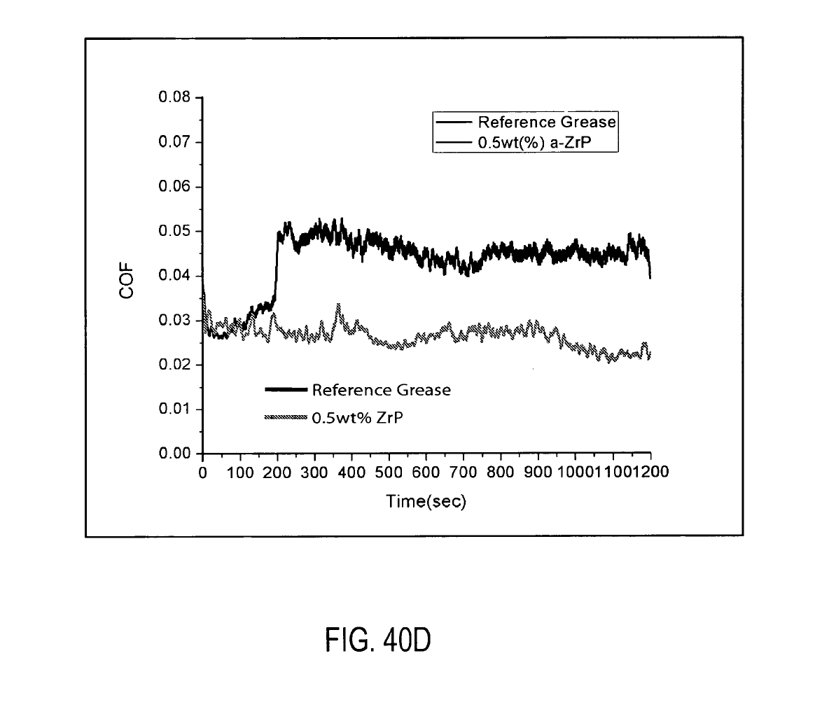

Wear rate is measured in mm3/N×mm. The wear rate was reduced by 52.3% in the presence of 0.5 wt % α-ZrP in comparison to the reference grease. FIG. 40A. The wear rate was determined at a load of 3N, speed of 150 RPM, and time of 2 hours. The wear depth was decreased by 50.7% and the wear width was decreased by 3.17%. FIG. 40B, FIG. 40C. The friction response was 43.23% greater with the reference grease than with 0.5 wt % α-ZrP. FIG. 40D.

The presence of α-ZrP makes the surface smoother. The surface roughness average (μm) was 65% less with 0.5 wt % α-ZrP than with the reference grease. There was a significant difference in roughness in the presence of α-ZrP, prevention of irregularity on the surface, and proof of reduced friction.

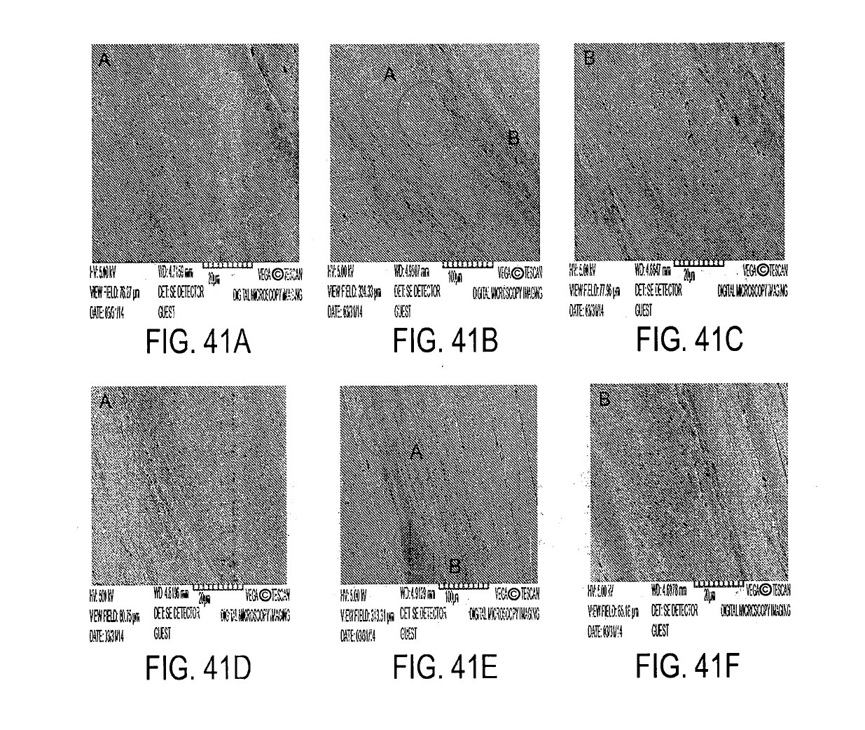

α-ZrP reduces deformation in the contact area. A comparison of the morphology of the wear track with the reference grease and with the addition of α-ZrP indicates that the addition of α-ZrP results in a smooth surface instead of deformation. FIG. 41A-FIG. 41F.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

What is claimed is:

1. A suspension, comprising:
a plurality of nanosheets, wherein a nanosheet has a length ranging from about 10 nm to about 10 μm; wherein the nanosheet has a thickness of less than 90 nm; and
a substance capable of suspending the plurality of nanosheets.

2. The suspension of claim 1 wherein the thickness is less than 50 nm.

3. The suspension of claim 1 wherein the nanosheets have an aspect ratio of at least 10.

4. The suspension of claim 1 wherein the nanosheets are comprised of one of the group consisting of: graphene, fluoro-graphene, graphene oxide, BCN, h-BN, MoS₂, WS₂, MoSe₂, WSe₂, TiTe₃, MnPS₃, MoTe₂, WTe₂, ZrS₂, ZrSe₂, TiS₂, VSe₂, GaSe, GaTe, InSe, Bi₂Se₃, Bi₂Te₃, Bi₂MnTe₄, NbSe₂, NbS₂, LaSe, TaS₂, NiSe₂, semiconducting chalcogenides, metallic dichalcogenide, micas, BSCCO, MoO₃, WO₃, TiO₂, MnO₂, V₂O₅, TaO₃, RuO₂, Y₂O₃, TiNbO₅, K_{0.8}H_{3.2}Nb₆O₁₇, LaNb₂O₇, La_{0.90}Eu_{0.05}Nb₂O₇, (Ca,Sr)₂Nb₃O₁₀, Ca₂Ta₂TiO₁₀, Bi₄Ti₃O₁₂, Bi₂SrTa₂O₉, Bi_{3.25}La_{0.75}Ti₃O₁₂, K₂NbO₃F, Ni(OH)₂, Mg(OH)₂, Sm(OH)₃, Er(OH)₃, Eu(OH)₃, Y(OH)₃, Co—Al(OH)ₓ, Mg—Al(OH)ₓ, perovskite-type oxides, hydroxides, Ti₃AlC₂, Ti₂AlC, Ta₄AlC₃, (Ti_{0.5},Nb_{0.5})₃AlC, (V_{0.5}Cr_{0.5})₃AlC₂, Ti₃AlCN, zirconium phosphates, abrasives, Al₂O₃, SiO₂, CeO₂, and diamond particles.

5. The suspension of claim 4 wherein the nanosheets are comprised of Y₂O₃.

6. The suspension of claim 4 wherein the nanosheets are comprised of zirconium phosphate.

7. The suspension of claim 6, wherein the zirconium phosphate is intercalated with one selected from the group consisting of ethylenediamine, propylamine, and butylamine.

8. The suspension of claim 1 wherein the concentration of the nanosheets in the substance is between 0.0004 wt % and 1.0 wt %.

9. The suspension of claim 8 wherein the concentration of the nanosheets in the substance is 0.5 wt %.

10. The suspension of claim 1 wherein the substance is selected from the group consisting of water, mineral oil, paraffinic oil, naphthenic oil, synthetic hydrocarbon fluids, ester oil, silicone oil, polyphenyl ethers (PPE), perfluoropolyether (PFPE), hydrogenated polyolefins, synthetic oil, vegetable oil, and animal fats.

11. The suspension of claim 1 wherein the nanosheets have a major face that is substantially square, rectangular, circular, other polygon-shaped, or irregularly shaped.

12. The suspension of claim 1 wherein the suspension is a lubricant.

13. The suspension of claim 12 wherein the lubricant is selected from the group consisting of grease, standard thread compounds, and petroleum jelly.

14. A method of lubricating a surface comprising applying the lubricant of claim 12 to a surface.

15. The method of claim 14 wherein the nanosheets are comprised of one of the group consisting of: graphene, fluoro-graphene, graphene oxide, BCN, h-BN, MoS₂, WS₂, MoSe₂, WSe₂, TiTe₃, MnPS₃, MoTe₂, WTe₂, ZrS₂, ZrSe₂, TiS₂, VSe₂, GaSe, GaTe, InSe, Bi₂Se₃, Bi₂Te₃, Bi₂MnTe₄, NbSe₂, NbS₂, LaSe, TaS₂, NiSe₂, semiconducting chalcogenides, metallic dichalcogenide, micas, BSCCO, MoO₃, WO₃, TiO₂, MnO₂, V₂O₅, TaO₃, RuO₂, Y₂O₃, TiNbO₅, K_{0.8}H_{3.2}Nb₆O₁₇, LaNb₂O₇, La_{0.90}Eu_{0.05}Nb₂O₇, (Ca,Sr)₂Nb₃O₁₀, Ca₂Ta₂TiO₁₀, Bi₄Ti₃O₁₂, Bi₂SrTa₂O₉, Bi_{3.25}La_{0.75}Ti₃O₁₂, K₂NbO₃F, Ni(OH)₂, Mg(OH)₂, Sm(OH)₃, Er(OH)₃, Eu(OH)₃, Y(OH)₃, Co—Al(OH)ₓ, Mg—Al(OH)ₓ, perovskite-type oxides, hydroxides, Ti₃AlC₂, Ti₂AlC, Ta₄AlC₃, (Ti_{0.5},Nb_{0.5})₃AlC, (V_{0.5}Cr_{0.5})₃AlC₂, Ti₃AlCN, zirconium phosphates, abrasives, Al₂O₃, SiO₂, CeO₂, and diamond particles.

16. The method of claim 15 wherein the nanosheets are comprised of Y₂O₃.

17. The method of claim 15 wherein the nanosheets are comprised of zirconium phosphate.

18. The method of claim 17, wherein the zirconium phosphate is intercalated with one selected from the group consisting of ethylenediamine, propylamine, and butylamine.

19. The method of claim 14 wherein the concentration of the nanosheets in the substance is between 0.0004 wt % and 1.0 wt %.

20. The method of claim 14 wherein the concentration of the nanosheets in the substance is 0.5 wt %.
